(19) United States
(12) Patent Application Publication
(10) Pub. No.: US 2025/0115512 A1
(43) Pub. Date: Apr. 10, 2025

(54) ALKALI BOROSILICATE GLASS, CURVED GLASS, LAMINATED GLASS, ARCHITECTURAL WINDOW GLASS AND VEHICLE WINDOW GLASS

(71) Applicant: AGC Inc., Tokyo (JP)

(72) Inventors: Takato KAJIHARA, Tokyo (JP); Shigeki SAWAMURA, Tokyo (JP)

(73) Assignee: AGC Inc., Tokyo (JP)

(21) Appl. No.: 18/985,493

(22) Filed: Dec. 18, 2024

Related U.S. Application Data
(63) Continuation of application No. PCT/JP2023/021633, filed on Jun. 9, 2023.

(30) Foreign Application Priority Data
Jun. 20, 2022 (JP) 2022-099058

(51) Int. Cl. C03C 3/091; B32B 17/10

(52) U.S. Cl. CPC C03C 3/091; B32B 17/10036; B32B 17/10119; B32B 17/10137; B32B 17/10449; B32B 2250/40; B32B 2307/54; B32B 2419/00; B32B 2605/08

(57) ABSTRACT

The present invention relates to an alkali borosilicate glass, in which a content of total iron in terms of Fe₂O₃ is 0.03% or more in mol % in terms of oxides, a ratio of three-coordinated boron to a total amount of the three-coordinated boron and four-coordinated boron is 61% or less, the alkali borosilicate glass is substantially free of Se and CoO, when a thickness of the alkali borosilicate glass is converted into 2.0 mm, a solar transmittance Te specified in ISO-9050:2003 is 90% or less, a dominant wavelength Dw measured using a standard C light source specified in JIS Z 8701:1999 is 520 nm or more and 574 nm or less, and an excitation purity Pe measured using the standard C light source specified in JIS Z 8701:1999 is 4.0% or less.

### CROSS-REFERENCE TO RELATED APPLICATIONS

This is a bypass continuation of International Application No. PCT/JP2023/021633 filed on Jun. 9, 2023, and claims priority from Japanese Patent Application No. 2022-099058 filed on Jun. 20, 2022, the entire content of which is incorporated herein by reference.

### TECHNICAL FIELD

The present invention relates to an alkali borosilicate glass, a bent glass, a laminated glass, an architectural window glass, and a vehicular window glass.

### BACKGROUND ART

In recent years, a vehicular glass, including an automobile glass, is required to have a heat shielding property from the viewpoint of energy conservation. By using a glass having a high heat shielding property for vehicles, a temperature rise in the vehicle due to solar radiation can be prevented, and an air-conditioning load can be reduced.

In addition, a gray glass is required for the vehicular glass from the viewpoint of excellent designability and protection of privacy in the vehicle. Patent Literatures 1 and 2 disclose that a gray glass can be obtained by adding CoO or Se as a coloring component to a soda-lime silica-based glass.

In addition to the above properties, the vehicular glass is required to be lighter in weight from the viewpoint of fuel consumption and power consumption. An alkali borosilicate glass is an example of a glass having a specific gravity smaller than that of a soda-lime silica-based glass which is a general glass for the vehicular glass.

The alkali borosilicate glass is preferred as the vehicular glass since it has a small specific gravity and also has excellent flying stone resistance. Patent Literature 3 discloses a vehicular glass using an alkali borosilicate glass. In addition, Patent Literature 4 discloses that a gray glass can be obtained by adding CoO to an alkali borosilicate glass. Further, Patent Literature 5 discloses that a gray glass can be obtained by adding Fe₂O₃ and Er₂O₃ in an alkali borosilicate glass.

### CITATION LIST

### Patent Literature

Patent Literature 1: JPH09-301736A

Patent Literature 2: JP2001-019470A

Patent Literature 3: US2018/0194114A1

Patent Literature 4: JPH07-109147A

Patent Literature 5: JPH04-280834A

### SUMMARY OF INVENTION

### Technical Problem

In Patent Literatures 1, 2, and 4, Se and CoO are used to obtain a gray color glass, but since these components are harmful to a human body, it is desirable to obtain a gray color glass without using these components.

In addition, in the alkali borosilicate glass disclosed in Patent Literature 5, Se and CoO are not essential components, but its gray color is weak and it is insufficient from the viewpoint of designability.

The present invention has been made in view of the above problems, and an object thereof is to provide an alkali borosilicate glass, a bent glass, and a laminated glass, which have an excellent heat shielding property, which are free of harmful elements, and which have excellent designability, and an architectural window glass or a vehicular window glass using the alkali borosilicate glass or the laminated glass.

### Solution to Problem

The inventors of the present invention have found that when ratios of three-coordinated boron and four-coordinated boron are adjusted in a glass, a gray color can be imparted to the glass. Thus, the present invention has been completed.

That is, the present invention is as follows.

[1] An alkali borosilicate glass, in which
a content of total iron in terms of Fe₂O₃ is 0.03% or more in mol % in terms of oxides,
a ratio of three-coordinated boron to a total amount of the three-coordinated boron and four-coordinated boron is 61% or less,
the alkali borosilicate glass is substantially free of Se and CoO,
when a thickness of the alkali borosilicate glass is converted into 2.0 mm, a solar transmittance Te specified in ISO-9050:2003 is 90% or less,
a dominant wavelength Dw measured using a standard C light source specified in JIS Z 8701:1999 is 520 nm or more and 574 nm or less, and
an excitation purity Pe measured using the standard C light source specified in JIS Z 8701:1999 is 4.0% or less.

[2] The alkali borosilicate glass according to [1], in which a ratio (Tv/Te) is 1.05 or more when the thickness of the alkali borosilicate glass is converted into 2.0 mm, provided that Tv is a visible light transmittance defined in ISO-9050:2003 using a D65 light source and Te is the solar transmittance defined in ISO-9050:2003.

[3] The alkali borosilicate glass according to [1] or [2], in which a visible light transmittance Tv defined in ISO-9050:2003 using a D65 light source is 75% or more when the thickness of the alkali borosilicate glass is converted into 2.0 mm.

[4] The alkali borosilicate glass according to [1] or [2], in which a visible light transmittance Tv defined in ISO-9050:2003 using a D65 light source is less than 75% when the thickness of the alkali borosilicate glass is converted into 2.0 mm.

[5] The alkali borosilicate glass according to any one of [1] to [4], in which the content of the total iron in terms of Fe₂O₃ is 0.040% or more and 0.60% or less in mol % in terms of oxides.

[6] The alkali borosilicate glass according to any one of [1] to [5], in which a Young's modulus is 65 GPa or more.

[7] The alkali borosilicate glass according to any one of [1] to [6], in which a temperature T₁₁ at which a glass viscosity is 1011 (dPa·s) is 640° C. or lower.

[8] The alkali borosilicate glass according to any one of [1] to [7], including, in mol % in terms of oxides:
70%≤SiO₂≤80%;
8.0%≤B₂O₃≤20%;
1.0%≤Al₂O₃≤5.0%;
0.0%≤Li₂O≤5.0%;
2.0%≤Na₂O≤10%;
0.0%≤K₂O≤5.0%;
0.0%≤MgO≤5.0%;
0.0%≤CaO≤5.0%;
0.0%≤SrO≤5.0%;
0.0%≤BaO≤5.0%;
89%≤SiO₂+B₂O₃+Al₂O₃; and
5.0%≤Li₂O+Na₂O+K₂O.

[9] The alkali borosilicate glass according to any one of [1] to [8], in which the content of the total iron in terms of Fe₂O₃ is 0.040% or more and 0.60% or less in mol % in terms of oxides, and a mass ratio of divalent iron in terms of Fe₂O₃ in the total iron in terms of Fe₂O₃ is 10% or more.

[10] The alkali borosilicate glass according to any one of [1] to [9], including LizO.

[11] A bent glass including the alkali borosilicate glass according to any one of [1] to [10].

[12] A laminated glass including:
a first glass plate;
a second glass plate; and
an interlayer sandwiched between the first glass plate and the second glass plate, in which
the first glass plate is the alkali borosilicate glass according to any one of [1] to [10], or the bent glass according to [11].

[13] The laminated glass according to [12], in which the second glass plate is the alkali borosilicate glass according to any one of [1] to [10], or the bent glass according to [11].

[14] The laminated glass according to [12], in which the second glass plate is an alkali aluminosilicate glass including 1.0% or more of Al₂O₃ in mol % in terms of oxides.

[15] The laminated glass according to [12], in which the second glass plate is an alkali aluminoborosilicate glass including 1.0% or more of Al₂O₃ and 1.0% or more of B₂O₃ in mol % in terms of oxides.

[16] The laminated glass according to [12], in which the second glass plate is a chemically strengthened glass.

[17] The laminated glass according to [12], in which the second glass plate is a soda-lime glass.

[18] A vehicular window glass including the alkali borosilicate glass according to any one of [1] to [10], or the bent glass according to [11].

[19] A vehicular window glass including the laminated glass according to any one of to [17].

[20] An architectural window glass including the alkali borosilicate glass according to any one of [1] to [10], or the bent glass according to [11].

### Advantageous Effects of Invention

According to the present invention, it is possible to provide an alkali borosilicate glass, a bent glass, and a laminated glass, which have an excellent heat shielding property, which are free of harmful elements, and which have excellent designability, and an architectural window glass or a vehicular window glass using the alkali borosilicate glass or the laminated glass.

### BRIEF DESCRIPTION OF DRAWINGS

FIG. 1 is a diagram showing transmission spectra in Example 1, Example 6, Example 9, and Example 11.

FIG. 2 is a graph showing a relationship between a ratio of three-coordinated boron and a dominant wavelength Dw.

FIG. 3 is a graph showing a relationship between the ratio of the three-coordinated boron and an excitation purity Pe.

FIG. 4 is a cross-sectional view of an example of a laminated glass according to one embodiment of the present invention.

FIG. 5 is a conceptual view illustrating a state where the laminated glass according to the embodiment of the present invention is used as a vehicular window glass.

FIG. 6 is an enlarged view of a portion S in FIG. 5.

FIG. 7 is a cross-sectional view taken along a line Y-Y in FIG. 6.

### DESCRIPTION OF EMBODIMENTS

Hereinafter, embodiments of the present invention will be described in detail. In the following drawings, members and portions having the same functions may be denoted by the same reference numerals, and duplicate descriptions may be omitted or simplified. The embodiments described in the drawings are schematic for the purpose of clearly illustrating the present invention, and do not necessarily accurately represent a size or a scale of an actual product.

In the present description, the expression that a glass “is substantially free of” a component means that the component is not contained except for inevitable impurities, and means that the component is not positively added. Specifically, it means that the content of each of these components in the glass is about 10 ppm by mole or less. Note that, the expression that “being substantially free of” Se and CoO means that the content of each of these components in the glass is 1 ppm by mole or less.

An alkali borosilicate glass according to the present embodiment has a content of total iron, in terms of Fe₂O₃, of 0.03% or more in mol % in terms of oxides, and a ratio of three- coordinated boron to a total amount of the three-coordinated boron and four-coordinated boron of 61% or less, and is substantially free of Se and CoO, and when a thickness of the alkali borosilicate glass is converted to 2.0 mm, a solar transmittance Te is 90% or less, a dominant wavelength Dw is 520 nm or more and 574 nm or less, and an excitation purity Pe is 4.0% or less.

In the alkali borosilicate glass according to the present embodiment (hereinafter, may be simply referred to as a glass), Fe₂O₃ is an essential component and is contained to impart a heat shielding property and a gray color to the glass. In the glass according to the present embodiment, the content of the total iron in terms of Fe₂O₃ is 0.03% or more in mol % in terms of oxides. The content of the total iron in terms of Fe₂O₃ here refers to a total amount of iron including FeO which is an oxide of divalent iron and Fe₂O₃ which is an oxide of trivalent iron.

When the content of the total iron in terms of Fe₂O₃ is 0.03% or more in the glass according to the present embodiment, a decrease in visible light transmittance can be prevented, a glass that is suitable for a vehicular window glass and the like can be produced, and melting of raw materials during production is easy.

When the content of the total iron in terms of Fe₂O₃ is less than 0.03% in the glass according to the present embodiment, the glass may not be able to be used for applications requiring the heat shielding property, and it may be necessary to use an expensive raw material having a low iron content for producing the glass. Further, when the content of the total iron in terms of Fe₂O₃ is less than 0.03%, heat radiation may reach a bottom surface of a melting furnace more than necessary during glass melting, and a load may be applied to a melting kiln. In the glass according to the present embodiment, the content of the total iron in terms of Fe₂O₃ is preferably 0.040% or more, more preferably 0.060% or more, still more preferably 0.080% or more, particularly preferably 0.10% or more, and most preferably 0.12% or more.

In addition, iron has a color under visible light. Therefore, when the content of the total iron in terms of Fe₂O₃ is excessively large, a visible light transmittance Tv decreases, making the glass not preferred for use in a vehicular windshield and door glass. In addition, the excitation purity Pe to be described later increases, and a color tone of the glass is darker. As a result, the color tone of the glass no longer has a gray color, which is not preferred. In the glass according to the present embodiment, the content of the total iron in terms of Fe₂O₃ is preferably 0.60% or less, more preferably 0.50% or less, still more preferably 0.40% or less, particularly preferably 0.30% or less, and most preferably 0.25% or less. That is, in the glass according to the present embodiment, the content of the total iron in terms of Fe₂O₃ is, for example, 0.03% or more and 0.60% or less in mol % in terms of oxides.

In the glass according to the present embodiment, the ratio of the three-coordinated boron to the total amount of the three-coordinated boron and the four-coordinated boron is 61% or less. The inventors of the present invention have found that when the ratio of the three-coordinated boron to the total amount of the three-coordinated boron and the four-coordinated boron is 61% or less in the glass, the glass exhibits a gray color and has excellent designability even without Se and CoO.

In the glass, boron can have an oxygen coordination number of three or four. Four-coordinated boron enters the glass framework and forms a tetrahedral structure. Here, since the tetrahedral structure is negatively charged, the charge is compensated for by alkali metal ions or alkaline earth metal ions. Thus, the four-coordinated boron forms a three-dimensional glass structure with little generation of non-bridging oxygen. On the other hand, it is known that the three-coordinated boron has non-bridging oxygen in the glass and forms a planar structure such as a ring structure (boroxol ring).

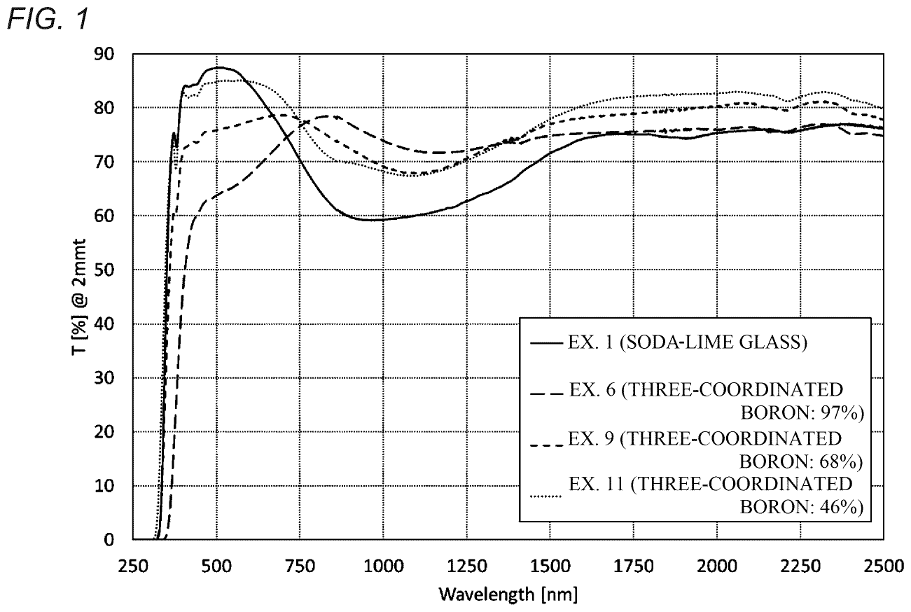

FIG. 1 is a diagram showing transmission spectra of glass plates in Example 1, Example 6, Example 9, and Example 11 to be described later. The glass according to the present embodiment contains boron and iron, and therefore, as shown in the transmission spectrum of Example 11 in FIG. 1, a light absorption spectrum of Fe ions in a wavelength range of 400 nm to 650 nm has a flat shape compared to a soda-lime silica-based glass in Example 1. However, when the ratio of the three-coordinated boron increases, there is a tendency that two broad absorption bands increase, centered on wavelengths of 350 nm and 500 nm, as in Example 6 and Example 9. The broad absorption band around a wavelength of 500 nm is thought to be due to inter valence charge transfer transition (IVCT) between Fe²⁺ and Fe³⁺ contained in the glass. The mechanism by which the inter valence charge transfer transition between Fe²⁺ and Fe³⁺ occurs when the ratio of the three-coordinated boron increases is not clear, but is thought to be that the planar structure formed by the presence of the three-coordinated boron generates a cluster structure in which the Fe atoms in the glass are close to each other, and the closer the distance between Fe²⁺ and Fe³⁺, the more likely the charge transfer transition occurs.

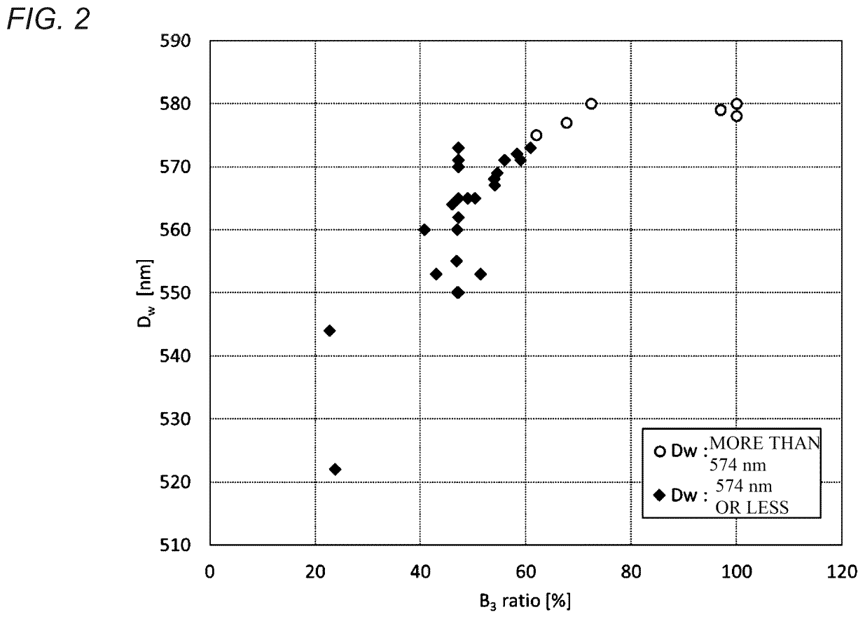

As shown in FIG. 1, when the ratio of the three-coordinated boron increases, the visible light transmittance decreases greatly, which greatly influences the color tone of the glass. FIG. 2 is a diagram showing a relationship between the dominant wavelength Dw measured by using a standard C light source specified in JIS Z 8701:1999 and the ratio of the three-coordinated boron for glasses in Examples and Comparative Examples to be described later. As shown in FIG. 2, it can be seen that when the ratio of the three-coordinated boron increases, that is, when the transmittance in the visible range by IVCT decreases, the dominant wavelength Dw increases and the glass exhibits a brown color.

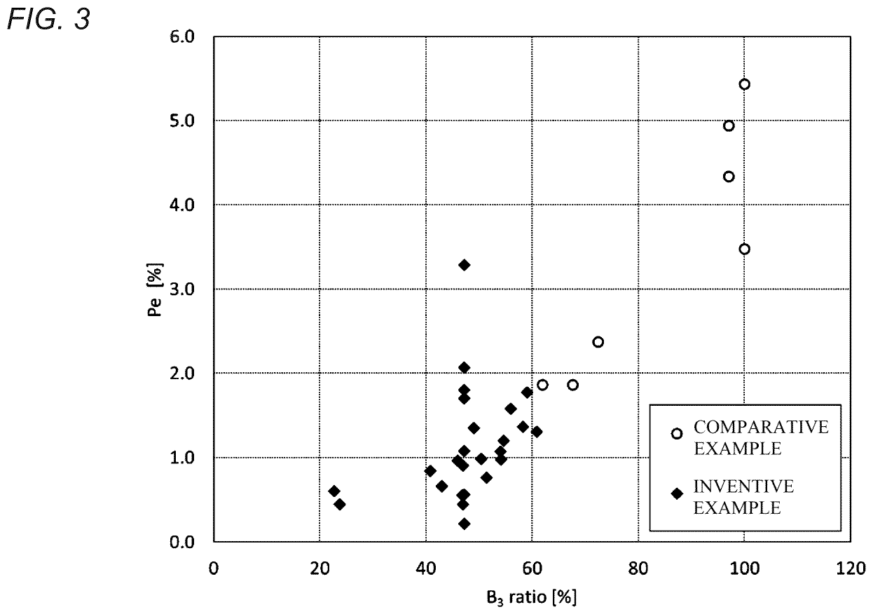

FIG. 3 is a diagram showing a relationship between the excitation purity Pe measured using the standard C light source specified in JIS Z 8701:1999 and the ratio of the three-coordinated boron for the glasses in Examples and Comparative Examples to be described later. As shown in FIG. 3, it can be seen that when the ratio of the three-coordinated boron increases, the excitation purity Pe also increases. As described above, controlling the ratio of the three-coordinated boron is important to obtain a glass having excellent designability, and when the ratio of the three-coordinated boron is 61% or less, it is possible to achieve an achromatic gray glass having a dominant wavelength Dw of 574 nm or less and a small excitation purity Pe.

In addition, when the ratio of the three-coordinated boron decreases in the glass according to the present embodiment, the glass exhibits a gray color and has an increased Young's modulus, making the glass more suitable for use in vehicles and architectures. The reason for the improvement in Young's modulus is thought to be that when the ratio of the three-coordinated boron decreases and the ratio of the four-coordinated boron increases, the amount of non-bridging oxygen decreases and a dense structure is formed, so that the ionic packing density or bond dissociation energy that contributes to the Young's modulus increases.

Therefore, in the present embodiment, the ratio of the three-coordinated boron to the total amount of the three-coordinated boron and the four-coordinated boron is 61% or less, preferably 60% or less, more preferably 59% or less, still more preferably 58% or less, particularly preferably 56% or less, and most preferably 54% or less.

In addition, the ratio of the three-coordinated boron to the total amount of the three-coordinated boron and the four-coordinated boron is preferably 20% or more. When the ratio of the three-coordinated boron is 20% or more, flying stone resistance of the glass can be improved. The reason for the improvement in flying stone resistance is thought to be that when the ratio of the three-coordinated boron increases, in addition to increasing the amount of non-bridging oxygen compared to the four-coordinated boron, the three-coordinated boron forms a planar structure, which loosens the network structure of the glass. As a result, when a flying stone collides with the glass, the network structure of the glass is denser, energy from the collision is dissipated, cracks are prevented, and the flying stone resistance is improved. The ratio of the three-coordinated boron to the total amount of the three-coordinated boron and the four-coordinated boron is more preferably 30% or more, still more preferably 35% or more, even more preferably 37% or more, particularly preferably 39% or more, and most preferably 41% or more. That is, the ratio of the three-coordinated boron to the total amount of the three-coordinated boron and the four-coordinated boron is, for example, 20% or more and 61% or less.

The ratios of the three-coordinated boron and the four-coordinated boron can be adjusted by adjusting a composition of the glass. Specifically, it can be adjusted by appropriately adjusting contents of an alkali metal oxide, an alkaline earth metal oxide, and Al₂O₃.

As described above, the four-coordinated boron is charge-assisted by alkali metal ions and is present as a tetrahedral structure in the glass. That is, when an alkali metal oxide is added to the glass, it is consumed in the formation of four-coordinated boron, and boron that is not coordinated to the alkali metal ion is present as three-coordinated boron. Therefore, by increasing the content of the alkali metal oxide, the ratio of the three-coordinated boron in the glass decreases, and the gray color of the glass is intensified.

At this time, it is necessary to take into consideration the content of Al₂O₃. It is known that Al has an oxygen coordination number of 4 to 6 in the glass. Among these, four-coordinated Al forms the glass structure as a tetrahedral structure. Since the four-coordinated Al is negatively charged similar to the four-coordinated boron, the charge is compensated for by alkali metal ions. At this time, the alkali metal ions present in the glass preferentially coordinate to Al over boron. Specifically, for example, in the case of a glass in which a content ratio of A1₂O₃, an alkali metal oxide, and B₂O₃ is 1:1:1, almost all the alkali metal oxide is consumed in the formation of the four-coordinated Al. In the case of no charge compensation by the alkali metal ions, boron is present as three-coordinated boron, so that at the above ratio, almost all the boron in the glass is present as the three-coordinated boron.

In addition, similar to the alkali metal oxide, the alkaline earth metal oxide also influences the coordination number of boron. In particular, since ions having a smaller electronegativity are more likely to react with boron to increase the amount of the four-coordinated boron, the ratio of the four-coordinated boron tends to increase in the order of Ba, Sr, Ca, and Mg, which have a smaller electronegativity.

Therefore, the ratios of the three-coordinated boron and the four-coordinated boron are adjusted by adjusting the contents of the alkali metal oxide, the alkaline earth metal oxide, and Al₂O₃.

The ratios of the three-coordinated boron and the four-coordinated boron in the glass can be measured by nuclear magnetic resonance (NMR). Specifically, the ratios can be measured by the method described in Examples to be described later. The glass according to the present embodiment has a solar transmittance Te specified in ISO-9050:2003 of 90% or less when the thickness is converted into 2.0 mm. When the Te is 90% or less, the heat shielding property of the glass is excellent. The Te is preferably 88% or less, more preferably 86% or less, still more preferably 84% or less, particularly preferably 82% or less, and most preferably 80% or less. The Te is not particularly limited in lower limit, and is generally 30% or more, preferably 32% or more, more preferably 34% or more, and particularly preferably 36% or more. That is, the Te is, for example, 30% or more and 90% or less.

The glass according to the present embodiment has a dominant wavelength Dw of 520 nm or more and 574 nm or less as measured using a standard C light source specified in JIS Z 8701:1999. The Dw is preferably 525 nm or more, more preferably 530 nm or more, still more preferably 535 nm or more, and most preferably 540 nm or more. In addition, the Dw is preferably 573 nm or less, more preferably 570 nm or less, still more preferably 567 nm or less, and most preferably 565 nm or less.

The glass according to the present embodiment has an excitation purity Pe of 4.0% or less as measured using the standard C light source specified in JIS Z 8701:1999. The Pe is preferably 3.5% or less, more preferably 3.0% or less, still more preferably 2.5% or less, particularly preferably 2.0% or less, and most preferably 1.5% or less. In addition, the Pe is not particularly limited in lower limit, and is generally 0.1% or more. That is, the Pe is, for example, 0.1% or more and 4.0% or less.

When the Dw and the Pe are within the above ranges, the glass has a gray color and exhibits excellent designability.

### Glass Composition

The glass according to the present embodiment is substantially free of Se and CoO. Se and CoO are generally used as components that impart a gray color to the glass, but on the other hand, these components are harmful to the human body. In the present embodiment, as described above, when the ratios of the three-coordinated boron and the four-coordinated boron are adjusted, a gray color can be imparted to the glass, so that a glass having excellent designability can be obtained without adding Se and CoO, which are harmful to the human body.

The glass according to the present embodiment preferably contains, in mol % in terms of oxides,
70%≤SiO₂≤80%,
8.0%≤B₂O₃≤20%,
1.0%≤Al₂O₃≤5.0%,
0.0%≤Li₂O≤5.0%,
2.0%≤Na₂O≤10%,
0.0%≤K₂O≤5.0%,
0.0%≤MgO≤5.0%,
0.0%≤CaO≤5.0%,
0.0%≤SrO≤5.0%, and
0.0%≤BaO≤5.0%, in which
SiO₂+B₂O₃+Al₂O₃≥89%, and
Li₂O+Na₂O+K₂O≥5.0%.

Hereinafter, a preferred composition range of each component contained in the glass according to the present embodiment will be described. Note that, the composition range of each component will hereinafter be expressed in mol % in terms of oxides unless otherwise specified.

SiO₂ is a component that contributes to increasing a Young's modulus, thereby making it easier to ensure strength required for vehicle applications, architectural applications, and the like. In the present embodiment, the content of SiO₂ is preferably 70% or more and 80% or less.

When the content of SiO₂ is 70% or more, a specific gravity of the glass is easily reduced and weather resistance can be ensured. In addition, an average linear expansion coefficient is prevented from increasing, and thermal cracking of the glass is prevented. The content of SiO₂ is more preferably 72% or more, still more preferably 73% or more, and particularly preferably 74% or more.

In addition, when the content of SiO₂ is 80% or less, an increase in viscosity during glass melting is prevented, glass production is easy, and formability for a vehicular window glass, particularly a windshield and the like, is improved. The content of SiO₂ is more preferably 79% or less, still more preferably 78% or less, and particularly preferably 77% or less.

As described above, B₂O₃ controls optical properties of the glass, reduces the specific gravity of the glass, and also contributes to improving the strength and meltability of the glass. In the present embodiment, the content of B₂O₃ is preferably 8.0% or more and 20% or less.

When the content of B₂O₃ is 8.0% or more, the optical properties of the glass are controlled, and a decrease in specific gravity of the glass and improvements in strength and meltability of the glass can be facilitated. The content of B₂O₃ is more preferably 8.5% or more, still more preferably 9.0% or more, particularly preferably 9.5% or more, and most preferably 10% or more.

In addition, when B₂O₃ is 20% or less, alkali elements are less likely to volatilize during glass melting and forming, and a decrease in glass quality can be prevented. In addition, acid resistance and alkali resistance can be improved. The content of B₂O₃ is more preferably 18% or less, still more preferably 16% or less, particularly preferably 15% or less, and most preferably 14% or less.

In the present embodiment, the content of Al₂O₃ is preferably 1.0% or more and 5.0% or less. When Al₂O₃ is 1.0% or more, four-coordinated Al₂O₃ coordinated with an alkali metal is generated, and thereby the amount of non-bridging oxygen in the glass is reduced, and the weather resistance, stain resistance, and chemical durability are improved. In addition, the average linear expansion coefficient is not excessively increased, the thermal cracking of the glass can be prevented, and a chemical strengthening treatment using ion exchange is possible. The content of Al₂O₃ is more preferably 1.1% or more, still more preferably 1.3% or more, particularly preferably 1.5% or more, and most preferably 1.7% or more.

In addition, when Al₂O₃ is 5.0% or less, the content of the alkali metal coordinated with boron increases, and the ratio of the three-coordinated boron can be reduced. In addition, an increase in viscosity during glass melting can be prevented, the glass production is easy, and the formability for a vehicular window glass, particularly a windshield and the like, is improved. The content of Al₂O₃ is more preferably 4.5% or less, still more preferably 4.0% or less, particularly preferably 3.5% or less, and most preferably 3.0% or less.

Li₂O is a component that improves the meltability of the glass with a small amount of addition, and a component that makes it easier to increase the Young's modulus and also contributes to a linear expansion coefficient of the glass. Further, Li₂O can also increase the ratio of the four-coordinated boron by coordinating lithium ions with boron. In the present embodiment, the content of Li₂O is preferably 0.0% or more and 5.0% or less.

When Li₂O is contained, the glass viscosity decreases, and thus the formability for a vehicular window glass, particularly a windshield and the like, is improved. In the case where Li₂O is contained in the glass according to the present embodiment, the content thereof is preferably 0.50% or more, more preferably 1.0% or more, still more preferably 1.5% or more, particularly preferably 1.7% or more, and most preferably 2.0% or more.

When the content of Li₂O is 5.0% or less, devitrification or phase separation during glass production is prevented, the glass production is easy, the linear expansion coefficient can be reduced, and the thermal cracking of the glass can be prevented. In addition, the effect of reducing a raw material cost is obtained since a lithium raw material is expensive. The content of Li₂O is more preferably 4.5% or less, still more preferably 4.0% or less, particularly preferably 3.5% or less, and most preferably 3.0% or less.

Na₂O is a component that improves the meltability of the glass, and a component that makes it easier to increase the Young's modulus and also contributes to the linear expansion coefficient of the glass. Further, Na₂O can coordinate with boron to increase the ratio of the four-coordinated boron, and can also improve the strength of the glass by performing a chemical strengthening treatment through ion exchange with K ions. In the present embodiment, the content of Na₂O is preferably 2.0% or more and 10% or less.

When 2.0% or more of Na₂O is contained, the glass viscosity decreases, and thus the formability of a vehicular window glass, particularly a windshield, is improved. The content of Na₂O is more preferably 3.5% or more, still more preferably 4.0% or more, particularly preferably 4.5% or more, and most preferably 5.0% or more.

When the content of Na₂O is 10% or less, the linear expansion coefficient can be reduced, and the thermal cracking of the glass can be prevented. In addition, the stain resistance of the glass is improved, so that the glass is suitable for use as a glass to be exposed to the atmosphere for a long period of time, such as a vehicular window glass and an architectural window glass. The content of Na₂O is more preferably 9.0% or less, still more preferably 8.5% or less, particularly preferably 8.0% or less, and most preferably 7.5% or less.

K₂O is a component that improves the meltability of the glass, and a component that increases the Young's modulus and also contributes to the linear expansion coefficient of the glass. In the present embodiment, the content of K₂O is preferably 0.0% or more and 5.0% or less.

When K₂O is contained, the glass viscosity decreases, and thus the formability for a vehicular window glass, particularly a windshield, is improved. Further, the ratio of the four-coordinated boron can be increased by coordination with boron. On the other hand, since K₂O has the effect of increasing the linear expansion coefficient and the specific gravity compared to Li₂O and Na₂O, it is desirable to add a smaller amount of K₂O than Li₂O and Na₂O. In the case where K₂O is contained, the content thereof is more preferably 0.10% or more, still more preferably 0.20% or more, particularly preferably 0.30% or more, extremely preferably 0.40% or more, and most preferably 0.50% or more.

When the content of K₂O is 5.0% or less, an increase in linear expansion coefficient or specific gravity can be prevented. The content of K₂O is more preferably 4.0% or less, still more preferably 3.5% or less, particularly preferably 3.0% or less, and most preferably 2.5% or less.

MgO is a component that promotes melting of a glass raw material and that improves the weather resistance and the stain resistance and increases the Young's modulus. Further, MgO can increase the ratio of the three-coordinated boron because of having a high electronegativity as described above. In the present embodiment, the content of MgO is preferably 0.0% or more and 5.0% or less. In the case where MgO is contained in the glass according to the present embodiment, the content thereof is more preferably 0.20% or more, still more preferably 0.50% or more, particularly preferably 0.70% or more, and most preferably 1.0% or more, in order to prevent the ratio of the three-coordinated boron from excessively increasing.

In addition, when the content of MgO is 5.0% or less, the glass is less likely to undergo devitrification, an increase in viscosity during glass melting is prevented, the glass production is easy, and the formability for a vehicular window glass, particularly a windshield and the like, is improved. Further, the ratio of the three-coordinated boron can be kept low. The content of MgO is more preferably 4.0% or less, still more preferably 3.5% or less, particularly preferably 3.0% or less, and most preferably 2.5% or less.

CaO is a component that improves the meltability of the glass raw material. Further, CaO can increase the ratio of the three-coordinated boron because of having a high electronegativity as described above. In the present embodiment, the content of CaO is preferably 0.0% or more and 5.0% or less. In the case where CaO is contained, the content thereof is more preferably 0.20% or more, still more preferably 0.50% or more, particularly preferably 0.70% or more, and most preferably 1.0% or more. Accordingly, the meltability of the glass raw material and the formability for a vehicular window glass, particularly a windshield and the like, are improved.

In addition, when the content of CaO is 5.0% or less, an increase in density of the glass is avoided, low brittleness is prevented, and the strength is maintained. Further, the ratio of the three-coordinated boron can be kept low. The content of CaO is more preferably 4.0% or less, still more preferably 3.5% or less, particularly preferably 3.0% or less, and most preferably 2.5% or less.

SrO is a component that improves the meltability of the glass raw material. Further, SrO can increase the ratio of the four-coordinated boron because of having an electronegativity lower than that of Mg or Ca, as described above. On the other hand, it is preferable not to intentionally contain SrO since it may increase the specific gravity of the glass, increase the brittleness of the glass, and decrease the strength of the glass. In the present embodiment, in the case where SrO is contained, the content thereof is more preferably 0.10% or more, still more preferably 0.20% or more, particularly preferably 0.30% or more, extremely preferably 0.40% or more, and most preferably 0.50% or more. Accordingly, the meltability of the glass raw material and the formability for a vehicular window glass, particularly a windshield and the like, are improved.

In addition, the content of SrO is preferably 5.0% or less. When the content of SrO is 5.0% or less, an increase in specific gravity of the glass can be prevented. In addition, an increase in density of the glass is avoided, low brittleness is prevented, and the strength is maintained. The content of SrO is more preferably 4.0% or less, still more preferably 3.0% or less, particularly preferably 2.0% or less, and most preferably 1.0% or less. That is, the content of SrO is preferably 0.0% or more and 5.0% or less.

BaO is a component that improves the meltability of the glass raw material. Further, BaO can increase the ratio of the four-coordinated boron because of having an electronegativity lower than that of Mg or Ca, as described above. On the other hand, it is preferable not to intentionally contain BaO since it may increase the specific gravity of the glass, increase the brittleness of the glass, and decrease the strength of the glass. In the case where BaO is contained, the content thereof is more preferably 0.10% or more, still more preferably 0.20% or more, particularly preferably 0.30% or more, extremely preferably 0.40% or more, and most preferably 0.50% or more. Accordingly, the meltability of the glass raw material and the formability for a vehicular window glass, particularly a windshield and the like, are improved.

In addition, the content of BaO is preferably 5.0% or less. When the content of BaO is 5.0% or less, an increase in specific gravity of the glass can be prevented. In addition, an increase in density of the glass is avoided, low brittleness is prevented, and the strength is maintained. The content of BaO is more preferably 4.0% or less, still more preferably 3.0% or less, particularly preferably 2.0% or less, and most preferably 1.0% or less. That is, the content of BaO is preferably 0.0% or more and 5.0% or less.

In the present embodiment, SiO₂+Al₂O₃+B₂O₃, that is, a total of the content of SiO₂, the content of Al₂O₃, and the content of B₂O₃ is preferably 89% or more. When the SiO₂+Al₂O₃+B₂O₃ is 89% or more, the specific gravity of the glass decreases, the weather resistance and the stain resistance of the glass are improved, and the linear expansion coefficient of the glass can be prevented from excessively increasing, making the glass suitable for use as a vehicular or architectural window glass. The SiO₂+Al₂O₃+B₂O₃ is more preferably 90% or more, and particularly preferably 91% or more.

The SiO₂+Al₂O₃+B₂O₃ is preferably 95% or less, more preferably 94% or less, and still more preferably 93% or less, from the viewpoint of improving the meltability of the glass raw material and the formability for a vehicular window glass, particularly a windshield and the like. That is, the SiO₂+Al₂O₃+B₂O₃ is preferably 89% or more and 95% or less.

In the present embodiment, a total content of Li₂O, Na₂O, and K₂O (hereinafter sometimes referred to as R₂O) is preferably 5.0% or more. When the R₂O is 5.0% or more, the ratio of the four-coordinated boron is increased, the Young's modulus is increased, the glass viscosity decreases, and the formability is improved, making the glass preferred for use as a vehicular window glass, particularly a windshield. In addition, the linear expansion coefficient can be increased within a range where the glass does not thermally crack, and the strength of the glass can be improved by performing an air-cooling strengthening treatment. The R₂O is more preferably 6.0% or more, still more preferably 6.5% or more, particularly preferably 7.0% or more, and most preferably 7.5% or more.

The R₂O is preferably 10% or less, more preferably 9.5% or less, and particularly preferably 9.0% or less, from the viewpoint of improving the stain resistance and preventing the ratio of the four-coordinated boron from being too large. That is, the R₂O is preferably 5.0% or more and 10% or less.

In addition, in Li₂O, Na₂O, and K₂O, Li₂O has the smallest molecular weight, contributes to making the glass lighter, and also contributes greatly to reducing the glass viscosity and increasing the Young's modulus. Therefore, in Li₂O, Na₂O, and K₂o, it is preferable to contain Li₂O. Further, it is preferable to contain two or more types of alkali metal components from the viewpoint of improving the stain resistance due to the alkali mixing effect and preventing phase separation and devitrification.

In the present embodiment, it represents a total content of MgO, CaO, SrO, and BaO (hereinafter, sometimes referred to as RO). The RO is preferably 0.0% or more and 5.0% or less. When the RO is 5.0% or less, the coordination number of boron can be controlled while preventing the brittleness of the glass from decreasing and maintaining the strength of the glass. The RO is more preferably 4.5% or less, still more preferably 4.0% or less, even more preferably 3.5% or less, even still more preferably 3.0% or less, particularly preferably 2.5% or less, and most preferably 2.0% or less.

In addition, the RO is more preferably 0.20% or more, still more preferably 0.50% or more, and particularly preferably 1.0% or more, from the viewpoint of improving the formability for a vehicular window glass, particularly a windshield.

In the glass according to the present embodiment, a mass ratio (%) of divalent iron in terms of Fe₂O₃ in the total iron in terms of Fe₂O₃ (hereinafter referred to as Fe-Redox) is preferably 10% or more. The Fe-Redox value is a ratio of a content of Fe²⁺ in terms of Fe₂O₃ to the content of the total iron in terms of Fe₂O₃. Therefore, it is an index representing a concentration of O₂ in the glass and represents an oxidation-reduction state.

When the Fe-Redox is 10% or more in the glass according to the present embodiment, the content of Fe²⁺, which has an absorption band in a near infrared region, can be increased, and as a result, the transmittance in the near infrared region can be reduced and the heat shielding property can be improved. The Fe-Redox is more preferably 14% or more, still more preferably 16% or more, and particularly preferably 18% or more. In addition, the Fe-Redox is preferably 70% or less. When the Fe-Redox is 70% or less, amber coloring caused by bonding of divalent negative sulfur ions (S²⁻) and trivalent iron ions (Fe³⁺) present in the glass is prevented, a decrease in transmittance in the visible region can be prevented, and the gray color of the glass can be maintained. The Fe-Redox is more preferably 65% or less, still more preferably 60% or less, and particularly preferably 55% or less. That is, the Fe-Redox is preferably 10% or more and 70% or less.

With the Fe-Redox, an oxidation-reduction degree of a glass melt can be controlled and adjusted based on the composition of the glass raw material, the melting temperature, and the use of a reducing agent such as coke or ammonium chloride.

The glass according to the present embodiment may contain components (hereinafter, also referred to as “other components”) other than the above SiO₂, Al₂O₃, B₂O₃, MgO, CaO, SrO, BaO, Li₂O, Na₂O, K₂O, and Fe₂O₃, and in the case where the other components are contained, a total content thereof is preferably 6.0% or less.

Examples of the other components include ZrO₂, Y₂O₃, TiO₂, CeO₂, Nd₂O₅, GaO₂, GeO₂, MnO₂, NiO, Cr₂O₃, V₂O₅, Er₂O₃, Au₂O₃, Ag₂O, CuO, CdO, MoO₃, SO₃, Cl, F, SnO₂, and Sb₂O₃, and the other components may be metal ions or oxides. The other components may be contained in a total amount of 6.0% or less for various purposes (for example, refining and coloring). When the total content of the other components is more than 6.0%, the SiO₂+A1₂O₃+B₂O₃ is smaller than 89%, and there is a risk of increasing the specific gravity and decreasing the weather resistance and the stain resistance of the glass. In addition, the amount of R₂O is smaller than 5.0%, and there is a risk of increasing the ratio of the three-coordinated boron, decreasing the Young's modulus, and increasing the glass viscosity. The content of the other components is more preferably 4.0% or less, still more preferably 2.0% or less, even more preferably 1.0% or less, particularly preferably 0.50% or less, and most preferably 0.10% or less.

Similar to Se, Er₂O₃ has the effect of adding a reddish tint to the glass, but is a rare element and is expensive, and is also not suitable for use in mass production processes such as a float method, a roll-out method, and a down draw method to be described later, from the viewpoint of reserves. Therefore, the content thereof is preferably less than 0.0015%, and it is more preferable that the glass is substantially free of Er₂O₃. In order to prevent adverse influences on the environment, the contents of As₂O₃ and PbO are each preferably less than 0.0015%, and it is more preferable that the glass is substantially free of As₂O₃ and PbO.

When the glass according to the present embodiment contains NiO, formation of NiS may cause glass breakage, and thus the content thereof is preferably 0.0080% or less. The content of NiO in the glass according to the present embodiment is more preferably 0.0040% or less, still more preferably 0.0020% or less, and it is particularly preferable that NiO is not substantially contained.

The glass according to the present embodiment may contain TiO₂. TiO₂ has an absorption band in an ultraviolet region, and thus reduces an ultraviolet transmittance Tuv and improves a UV cut performance. In the case where the glass according to the present embodiment contains TiO₂, the content thereof is preferably 0.010% or more, more preferably 0.040% or more, still more preferably 0.075% or more, and particularly preferably 0.15% or more. Since TiO₂ has a color under the visible light, there is a risk of decreasing the visible light transmittance Tv and changing the color tone of the glass from gray to brown. In the case where the glass according to the present embodiment contains TiO₂, the content thereof is preferably 0.80% or less, more preferably 0.50% or less, still more preferably 0.40% or less, and particularly preferably 0.30% or less. That is, the content of TiO₂ is preferably 0.0% or more and 0.80% or less.

The glass according to the present embodiment may contain CeO₂. CeO₂ has an absorption band in the ultraviolet region, and thus reduces the ultraviolet transmittance Tuv and improves the UV cut performance. In the case where the glass according to the present embodiment contains CeO₂, the content thereof is preferably 0.010% or more, more preferably 0.020% or more, still more preferably 0.040% or more, and particularly preferably 0.070% or more. CeO₂ absorbs ultraviolet light to cause solarization, the transmittance in the visible region may decreases, and the color tone of the glass may be no longer a gray color. In the case where the glass according to the present embodiment contains CeO₂, the content thereof is preferably 0.25% or less, more preferably 0.18% or less, still more preferably 0.14% or less, and particularly preferably 0.10% or less. That is, the content of CeO₂ is preferably 0.0% or more and 0.25% or less.

The glass according to the present embodiment may contain Cr₂O₃. Cr₂O₃ can act as an oxidant to control an amount of Fe²⁺. In the case where the glass according to the present embodiment contains Cr₂O₃, the content thereof is preferably 0.0020% or more, and more preferably 0.0040% or more. Since Cr₂O₃ has a color under the visible light, the visible light transmittance may be decreased. In the case where the glass according to the present embodiment contains Cr₂O₃, the content thereof is preferably 0.020% or less, more preferably 0.016% or less, still more preferably 0.012% or less, and particularly preferably 0.0080% or less. That is, the content of Cr₂O₃ is preferably 0.0% or more and 0.020% or less.

The glass according to the present embodiment may contain SnO₂. SnO₂ can act as a reducing agent to control an amount of FeO. In the case where the glass according to the present embodiment contains SnO₂, the content thereof is preferably 0.010% or more, more preferably 0.040% or more, still more preferably 0.060% or more, and particularly preferably 0.080% or more. On the other hand, in order to prevent defects derived from SnO₂ during the glass production, the content of SnO₂ in the glass according to the present embodiment is preferably 0.40% or less, more preferably 0.30% or less, still more preferably 0.20% or less, and particularly preferably 0.15% or less. That is, the content of SnO₂ is preferably 0.0% or more and 0.40% or less.

The glass according to the present embodiment may contain SO₃. SO₃ acts as a refining agent and therefore improves a bubble quality of the glass. In the case where the glass according to the present embodiment contains SO₃, the content thereof is preferably 0.0010% or more, more preferably 0.0040% or more, still more preferably 0.0070% or more, and particularly preferably 0.015% or more. In the case where the Fe-Redox is large, SO₃ may cause amber coloring and turn the glass brown. In the case where the glass according to the present embodiment contains SO₃, the content thereof is preferably 0.070% or less, more preferably 0.060% or less, still more preferably 0.050% or less, and particularly preferably 0.040% or less. That is, the content of SO₃ is preferably 0.0% or more and 0.070% or less.

The glass according to the present embodiment may contain Cl. Cl acts as a refining agent and therefore improves the bubble quality of the glass. In the case where the glass according to the present embodiment contains Cl, the content thereof is preferably 0.080% or more, more preferably 0.15% or more, still more preferably 0.20% or more, particularly preferably 0.30% or more, and most preferably 0.40% or more. When the content of Cl is excessively large, a Cl₂ gas volatilized from the glass melt may corrode surrounding members. In the case where glass according to the present embodiment contains Cl, the content thereof is preferably 1.5% or less, more preferably 1.2% or less, still more preferably 1.0% or less, and particularly preferably 0.80% or less. That is, the content of Cl is preferably 0.0% or more and 1.5% or less.

### Other Properties

### (Visible Light Transmittance: Tv)

In the glass according to the present embodiment, when the thickness is converted into 2.0 mm, the visible light transmittance Tv calculated by measuring the transmittance with a spectrophotometer using a D65 light source according to the provisions in ISO-9050:2003 is preferably 75% or more. When the Tv is 75% or more, the glass has excellent transparency and is thus suitable for use as a vehicular windshield and door glass. The Tv is more preferably 78% or more, and still more preferably 80% or more. The Tv is not particularly limited in upper limit, and is, for example, 91% or less. That is, the Tv is, for example, 75% or more and 91% or less.

In the glass according to the present embodiment, the absorption of the visible light can be adjusted by adjusting the ratios of the three-coordinated boron and the four-coordinated boron as described above, and therefore the glass according to the present embodiment can also be used as a vehicular rear glass. In the case where the glass according to the present embodiment is used as a vehicular rear glass, the Tv of the glass is preferably less than 75%, more preferably 72% or less, and still more preferably 70% or less.

The glass according to the present embodiment preferably has a small solar transmittance Te and a large visible light transmittance Tv. That is, Tv/Te is preferably 1.05 or more. When the Tv/Te is 1.05 or more, a glass exhibiting excellent transparency and heat shielding property is obtained, which is more suitable for use as a vehicular or architectural window glass. The Tv/Te is not particularly limited in upper limit, and is, for example, 1.30 or less. That is, the Tv/Te is, for example, 1.05 or more and 1.30 or less.

### (Ultraviolet Transmittance: Tuv)

The glass according to the present embodiment preferably has a low ultraviolet transmissibility, and when the thickness is converted into 2.0 mm, the ultraviolet transmittance Tuv defined in ISO-9050:2003 is preferably 65% or less. The Tuv is more preferably 60% or less, still more preferably 55% or less, particularly preferably 50% or less, and most preferably 45% or less. In addition, the Tuv is, for example, 5% or more. That is, the Tuv is, for example, 5% or more and 65% or less.

### (Young's Modulus)

The Young's modulus of the glass according to the present embodiment is preferably 65 GPa or more, more preferably 68 GPa or more, still more preferably 70 GPa or more, and particularly preferably 72 GPa or more. When the Young's modulus is within the above range, the glass has high rigidity and is suitable for use as a vehicular window glass and the like.

On the other hand, when the Young's modulus is too large, the glass is less likely to deform, may thus not be able to absorb the energy of a flying stone hitting it, and the glass may be cracked. Therefore, the Young's modulus is 80 GPa or less, more preferably 78 GPa or less, and still more preferably 75 GPa or less. That is, the Young's modulus is preferably 65 GPa or more and 80 GPa or less.

### (T₁₁)

In the glass according to the present embodiment, a temperature T₁₁ at which the glass viscosity is 10¹¹ [dPa·s] is preferably 640° C. or lower. When the T₁₁ is 640° C. or lower, it is possible to perform bending forming at a low temperature.

Examples of a method for setting the T₁₁ to 640° C. or lower include a method of increasing the contents of B₂O₃, R₂O, and RO and decreasing the content of Al₂O₃ in components of the glass, and a method of containing Li₂O among R₂O. In the glass according to the present embodiment, the T₁₁ is more preferably 620° C. or lower, still more preferably 615° C. or lower, even more preferably 610° C. or lower, particularly preferably 605° C. or lower, and most preferably 600° C. or lower.

In addition, the T₁₁ is preferably 560° C. or higher, more preferably 570° C. or higher, still more preferably 575° C. or higher, and particularly preferably 580° C. or higher, from the viewpoint of a firing temperature of a black ceramic to be printed on a windshield. That is, the T₁₁ is preferably 560° C. or higher and 640° C. or lower.

### (T₁₂)

In the glass according to the present embodiment, a temperature T₁₂ at which the glass viscosity is 10¹² [dPa·s] is preferably 600° C. or lower. When the T₁₂ is 600° C. or lower, it is possible to perform bending forming at a low temperature.

Examples of a method for setting the T₁₂ to 600° C. or lower include a method of increasing the contents of B₂O₃, R₂O, and RO and decreasing the content of Al₂O₃ in components of the glass, and a method of containing Li₂O among R₂O. In the glass according to the present embodiment, the T₁₂ is more preferably 595° C. or lower, still more preferably 590° C. or lower, even more preferably 585° C. or lower, particularly preferably 580° C. or lower, and most preferably 575° C. or lower.

In addition, the T₁₂ is preferably 540° C. or higher, more preferably 545° C. or higher, still more preferably 550° C. or higher, particularly preferably 555° C. or higher, and most preferably 560° C. or higher, from the viewpoint of the firing temperature of the black ceramic to be printed on a windshield. That is, the T₁₂ is preferably 540° C. or higher and 600° C. or lower.

### (Average Linear Expansion Coefficient)

The average linear expansion coefficient of the glass according to the present embodiment at 50° C. to 350° C. is preferably 40×10⁻⁷/° C. or more. When the average linear expansion coefficient of the glass according to the present embodiment is 40×10⁻⁷/° C. or more, the air-cooling strengthening treatment is easy, a difference in linear expansion coefficient with the black ceramic is small, and cracking of the black ceramic can be prevented. In order to set the average linear expansion coefficient within the above range, a method of increasing the contents of B₂O₃, R₂O, and RO and decreasing the content of Al₂O₃ in components of the glass can be used.

The average linear expansion coefficient of the glass according to the present embodiment at 50° C. to 350° C. is more preferably 45×10⁻⁷/° C. or more, still more preferably 47×10⁻⁷/° C. or more, particularly preferably 50×10⁻⁷/° C. or more, and most preferably 52×10⁻⁷/° C. or more.

On the other hand, when the average linear expansion coefficient of the glass according to the present embodiment is too large, a thermal stress due to a temperature distribution of the glass may be likely to occur in a forming step and a slow cooling step for the glass or a forming step for a windshield, and the thermal cracking of the glass may occur. In addition, when the average linear expansion coefficient of the glass according to the present embodiment is too large, in the case where the glass is used as a vehicular window glass or an architectural window glass, there is a risk of cracking due to heat shock. The average linear expansion coefficient of the glass according to the present embodiment at 50° C. to 350° C. may be 70×10⁻⁷/° C. or less, and is preferably 65×10⁻⁷/° C. or less, more preferably 63×10⁻⁷/° C. or less, and still more preferably 60×10⁻⁷/° C. or less. That is, the average linear expansion coefficient at 50° C. to 350° C. is preferably 40×10⁻⁷/° C. or more and 70×10⁻⁷/° C. or less.

### (Specific Gravity)

The glass according to the present embodiment preferably has a specific gravity of 2.40 or less.

A soda-lime-based glass, which is widely used as a vehicular window glass or architectural window glass, has a specific gravity of about 2.51. However, the glass according to the present embodiment is an alkali borosilicate glass having a specific gravity smaller than that of the soda-lime-based glass, and is therefore lightweight, and can be more suitably used as a vehicular or architectural window glass, from the viewpoint of fuel consumption and power consumption. The specific gravity of the glass according to the present embodiment is more preferably 2.38 or less, still more preferably 2.36 or less, and particularly preferably 2.34 or less. In addition, the specific gravity of the glass according to the present embodiment is preferably 2.25 or more, and more preferably 2.27 or more, from the viewpoint of improving a sound shielding property in the vehicle. That is, the specific gravity of the glass is preferably 2.25 or more and 2.40 or less.

The glass according to the present embodiment preferably has a T_{2.5} of 1,600° C. or lower. In the glass according to the present embodiment, a T₄ is preferably 1,200° C. or lower, and T₄-T_{L} is preferably −50° C. or more. Note that, in the present description, the T_{2.5} represents a temperature at which the glass viscosity is 10^{2.5} dPa·s, the T₄ represents a temperature at which the glass viscosity is 10⁴ dPa·s, and the TL represents a liquid phase temperature of the glass.

When the T_{2.5} or the T₄ of the glass according to the present embodiment is higher than predetermined temperature of them, it is difficult to produce a large glass with a float method, a roll-out method, a down draw method, or the like. In the glass according to the present embodiment, the T_{2.5} is more preferably 1,550° C. or lower, still more preferably 1,500° C. or lower, and particularly preferably 1,480° C. or lower. In the glass according to the present embodiment, the T₄ is more preferably 1,180° C. or lower, still more preferably 1,150° C. or lower, and particularly preferably 1,125° C. or lower.

The lower limit of each of the T_{2.5} and the T₄ of the glass according to the present embodiment is not particularly limited, and in order to maintain the weather resistance and the stain resistance, the T_{2.5} is typically 1,300° C. or higher, and the T₄ is typically 1,000° C. or higher. The T_{2.5} of the glass according to the present embodiment is preferably 1,350° C. or higher, and more preferably 1,380° C. or higher. The T₄ of the glass according to the present embodiment is preferably 1,020° C. or higher, and more preferably 1,050° C. or higher. That is, the T_{2.5} is preferably 1,300° C. or higher and 1,600° C. or lower, and the T₄ is preferably 1,000° C. or higher and 1,200° C. or lower.

Further, in order to enable production with a float method, the T₄-T_{L} of the glass according to the present embodiment is preferably −50° C. or more. When the difference is −50° C. or more, occurrence of devitrification in the glass during glass forming can be prevented, mechanical properties of the glass are improved, and further, a glass having improved transparency and an excellent quality can be obtained. The T₄-T_{L} of the glass according to the present embodiment is more preferably −25° C. or more, still more preferably 0° C. or more, and particularly preferably 20° C. or more.

In addition, the glass according to the present embodiment preferably has a T_{g} of 460° C. or higher and 580° C. or lower. Note that, in the present description, the T_{g} represents a glass transition point. When the T_{g} is within this predetermined temperature range, the glass can be bent within general production condition ranges. When the T_{g} of the glass according to the present embodiment is lower than 460° C., there is no problem in formability, but an alkali content or an alkaline earth content is too large, and problems that thermal expansion of the glass is excessive, and the weather resistance and the stain resistance decrease, and the like are likely to occur. In addition, when the T_{g} of the glass according to the present embodiment is lower than 460° C., the glass may devitrify and may not be formed in a forming temperature range.

The T_{g} of the glass according to the present embodiment is more preferably 480° C. or higher, still more preferably 490° C. or higher, and particularly preferably 500° C. or higher. On the other hand, the T_{g} of the glass according to the present embodiment is more preferably 570° C. or lower, still more preferably 565° C. or lower, and particularly preferably 560° C. or lower, from the viewpoint of facilitating production during glass bending.

In the alkali borosilicate glass according to the present embodiment, the presence of moisture in the glass has an effect of lowering the T₁₁ and the T₁₂, making bending and forming of the glass easier. Therefore, the alkali borosilicate glass according to the present embodiment preferably contains a certain amount of moisture. The moisture in the glass can be generally expressed by a value called a β-OH value, and the β-OH value is preferably 0.050 mm⁻¹ or more, more preferably 0.10 mm⁻¹ or more, still more preferably 0.15 mm⁻¹ or more, and particularly preferably 0.20 mm⁻¹ or more. The β-OH is obtained by the following equation based on a transmittance of the glass measured using a FT-IR (Fourier transform infrared spectrophotometer).

$$β - OH = ( 1 / X ) {log}_{10} ( {T}_{A} / {T}_{B} ) [ {mm}^{- 1} ]$$

X: sample thickness [mm]
T_{A}: transmittance [%] at a reference wave number of 4,000 cm⁻¹
T_{B}: minimum transmittance [%] near a hydroxy group absorption wave number of 3,600 cm⁻¹

On the other hand, when the amount of moisture in the glass is too large, the network structure of the glass may be influenced, resulting in a deterioration in flying stone resistance. Therefore, the β-OH value of the alkali borosilicate glass according to the present embodiment is preferably 0.70 mm⁻¹ or less, more preferably 0.60 mm⁻¹ or less, still more preferably 0.50 mm⁻¹ or less, and particularly preferably 0.40 mm⁻¹ or less. That is, the β-OH value is preferably 0.050 mm⁻¹ or more and 0.70 mm⁻¹ or less.

When the thickness of the glass according to the present embodiment is converted into 2.00 mm, L* defined in JIS Z 8781-4:2003 using a D65 light source is preferably 84.0 or more, more preferably 86.0 or more, still more preferably 88.0 or more, and even more preferably 90.0 or more. The L* is not particularly limited in upper limit, and is 100.0 or less. That is, the L* is preferably 84.0 or more and 100.0 or less.

When the thickness of the glass according to the present embodiment is converted into 2.00 mm, a* defined in JIS Z 8781-4:2003 using a D65 light source is preferably −5.0 or more, more preferably −3.0 or more, and still more preferably −2.0 or more. In addition, the a* is preferably 2.0 or less, more preferably 1.0 or less, and still more preferably 0.0 or less. That is, the a* is preferably −5.0 or more and 2.0 or less.

Further, when the thickness is converted into 2.00 mm, b* defined in JIS Z 8781-4:2003 using a D65 light source is preferably −5.0 or more, more preferably −3.0 or more, and still more preferably −1.0 or more. In addition, the b* is preferably 5.0 or less, more preferably 3.0 or less, still more preferably 2.0 or less, and particularly preferably 1.5 or less. That is, the b* is preferably −5.0 or more and 5.0 or less.

When the L*, the a*, and the b* are within the above ranges, the glass according to the present embodiment has excellent designability and can be suitably used as a vehicular or architectural window glass.

Further, in the glass according to the present embodiment, c* determined by c*={(a*)²+(b*)²}^{1/2} is preferably 3.5 or less, more preferably 3.0 or less, still more preferably 2.5 or less, and particularly preferably 2.0 or less. The smaller the c*, the lower the saturation and the darker the gray color the glass appears. In addition, the c* is not particularly limited in lower limit, and is generally 0.0 or more. That is, the c* is preferably 0.0 or more and 3.5 or less.

The glass according to the present embodiment is preferably, for example, a float glass formed by a known float method. In the float method, a molten glass base material is floated on a molten metal such as tin, and with a precise temperature control operation, it is possible to form a glass having a uniform thickness and plate width, and to obtain a glass having a large area.

Alternatively, a glass formed with a known roll-out method or down draw method may be used, or a glass having a polished surface and a uniform plate thickness may be used. Here, the down draw method is roughly classified into a slot down draw method and an overflow down draw method (fusion method), and both of the methods are methods in which a molten glass is continuously poured down from a formed body to form a glass ribbon in a band plate shape.

The shape of the glass according to the present embodiment is not particularly limited, and a main surface thereof has an area of preferably 250,000 mm² or more, more preferably 450,000 mm² or more, and still more preferably 900,000 mm² or more. When the area of the glass is within the above range, the glass can be suitable for various vehicle types. In addition, when the area of the glass is too large, difficulty of the bending and forming increases, such as difficulty in handling the glass, non-uniformity of a temperature distribution during heating, and deterioration of dimensional accuracy after the bending and forming. Therefore, the area of the main surface of the glass according to the present embodiment is preferably 4,000,000 mm² or less, more preferably 3,500,000 mm² or less, and still more preferably 3,000,000 mm² or less. That is, the area of the main surface of the glass according to the present embodiment is preferably 250,000 mm² or more and 4,000,000 mm² or less.

In addition, the glass according to the present embodiment preferably has a thickness of 0.50 mm or more in order to improve the rigidity and to improve the strength when the glass comes into contact with flying stones, vehicle keys, or the like. The thickness of the glass is more preferably 1.00 mm or more, still more preferably 1.50 mm or more, particularly preferably 2.00 mm or more, and most preferably 2.50 mm or more. In addition, the thickness of the glass according to the present embodiment is preferably 4.00 mm or less, more preferably 3.80 mm or less, and still more preferably 3.50 mm or less, from the viewpoint of preventing an increase in fuel consumption and power consumption due to an increase in glass weight. That is, the thickness of the glass is preferably 0.50 mm or more and 4.00 mm or less.

The glass according to the present embodiment may be a glass subjected to a strengthening treatment such as air-cooling strengthening or chemical strengthening. With the above treatment, the strength of the glass can be improved.

Here, the air-cooling strengthening is a treatment of forming a compressive stress layer on the surface of the glass by a thermal strengthening treatment. Specifically, a uniformly heated glass plate is rapidly cooled from a temperature near the softening point, and a compressive stress is generated on the surface of the glass due to a temperature difference between the surface of the glass and an inside of the glass. The compressive stress is generated uniformly over the entire surface of the glass, and a compressive stress layer having a uniform depth is formed over the entire surface of the glass. The thermal strengthening treatment is more suitable for strengthening a thick glass plate than a chemical strengthening treatment.

In addition, the chemical strengthening is a treatment in which alkali metal ions having a small ion radius (typically, Li ions or Na ions) on the surface of the glass are exchanged by alkali metal ions having a large ion radius (typically, Na ions or K ions) through ion exchange at a temperature equal to or lower than the glass transition point, thereby forming a compressive stress layer on the surface of the glass. The chemical strengthening treatment can be performed by a known method, for example, an ion exchange method. In the ion exchange method, a glass plate is immersed in a treatment solution (for example, potassium nitrate molten salt), and ions having a small ion radius (for example, Na ions) contained in the glass are exchanged for ions having a large ion radius (for example, K ions), thereby forming a compressive stress on the surface of the glass.

Each of a magnitude of the compressive stress on the surface of the glass plate (hereinafter, also referred to as a surface compressive stress CS) and a depth DOL of the compressive stress layer formed on the surface of the glass plate can be adjusted based on a glass composition, a chemical strengthening treatment time, and a chemical strengthening treatment temperature.

### [Bent Glass]

A bent glass according to the present embodiment includes the above alkali borosilicate glass. That is, it is formed by bending the above alkali borosilicate glass. The bent glass according to the present embodiment may be a bent glass obtained by forming a flat plate-shaped alkali borosilicate glass into a curved shape by gravity forming, press forming, or the like.

The bent glass according to the present embodiment is a glass that curves with a predetermined curvature, may be a single bent glass that curves only in one direction, either an up-and-down direction or a right-and-left direction, or may be a multi-bent glass that curves both in the up-and-down direction and the right-and-left direction.

The bent glass according to the present embodiment preferably has a minimum radius of curvature of 500 mm or more and 100,000 mm or less. Regarding the radius of curvature of the bent glass, the shape of the sample is calculated by a shape simulation using a laser displacement meter (Dyvoce manufactured by Kohzu Precision Co., Ltd.) based on an amount of warpage inherent in the sample, which is determined by self-weight deflection correction in a double-sided difference mode, and the radius of curvature is determined based on the shape obtained by the simulation.

### [Method for Producing Bent Glass]

In a method for producing a bent glass according to the present embodiment, a bent glass is formed by heating and bending the above alkali borosilicate glass.

Examples of a forming method for the bent glass include a method of bending and forming a heated glass in a state of being placed in a mold and pressing it from above using a press.

Other examples include a method of placing a flat plate-shaped glass on a mold having a bending and forming surface corresponding to a desired curved surface, carrying the mold into a heating furnace in this state, and heating the glass in the heating furnace to a temperature near the softening point of the glass. According to this forming method, since the glass curves along the bending and forming surface of the mold due to the own weight along with softening, a glass having a desired curved surface is produced.

In the present embodiment, from the viewpoint of improving productivity and improving surface accuracy after forming, the above bending and forming using a press is preferred. The above bending and forming method using a press is not particularly limited, and for example, the method described in WO 2016/093031 can be used as appropriate. Hereinafter, the above bending and forming method using a press will be exemplified.

First, the alkali borosilicate glass according to the present embodiment is transported to a press area using a transport conveyor or the like. Next, in the press area, the alkali borosilicate glass is softened by heating it to a temperature at which it can be bent and formed.

Here, the temperature at which the alkali borosilicate glass can be bent and formed is, for example, equal to or higher than the temperature T₁₁ at which the glass viscosity is 10¹¹ [dPa·s]. Note that, the heating may be performed using a heater or the like in the heating furnace in the process of transporting the alkali borosilicate glass to the press area using the transport conveyor or the like.

In addition, a bending and forming time under the condition that the heating temperature (≥T₁₁) is maintained can be set to, for example, 1 second or longer.

A lower press mold (female mold) and an upper press mold (male mold) are disposed at predetermined positions in the press area, and an upper surface shape of the female mold and a lower surface shape of the male mold correspond to the curved shape of the alkali borosilicate glass to be subjected to bending and forming in a conveying direction and an orthogonal direction. The female mold can be moved up and down between a standby position below the transport conveyor and a press position above the transport conveyor, and after the glass is transferred from the transport conveyor, is moved up from a predetermined raised position to the press position above the transport conveyor with the glass placed thereon, whereby the alkali borosilicate glass is subjected to press forming.

Next, the press-formed alkali borosilicate glass is transported to a cooling area using a transport shuttle or the like. In the cooling area, the alkali borosilicate glass is cooled by blowing cooling air onto the alkali borosilicate glass.

With the above steps, a bent glass is formed. Note that, although the bending and forming of the alkali borosilicate glass according to the present embodiment has been described above, the bending and forming may also be performed in the state of a laminated glass, which will be described later.

### [Laminated Glass]

A laminated glass according to the present embodiment includes: a first glass plate; a second glass plate; and an interlayer sandwiched between the first glass plate and the second glass plate, in which the first glass plate is the above alkali borosilicate glass or the above bent glass.

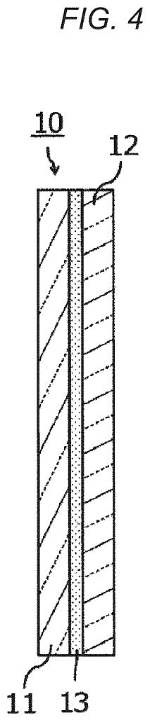

FIG. 4 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12. Note that, the laminated glass 10 according to the present embodiment is not limited to an aspect in FIG. 4, and can be modified without departing from the gist of the present invention. For example, the interlayer 13 may be formed as one layer as illustrated in FIG. 4, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment will be described as a configuration in which only two glass plates, that is, the first glass plate 11 and the second glass plate 12, are included, and the interlayer 13 is sandwiched therebetween.

In the laminated glass according to the present embodiment, the second glass plate 12 is preferably the above alkali borosilicate glass or the above bent glass, from the viewpoint of bending formability. In the case where the first glass plate 11 and the second glass plate 12 are each the above alkali borosilicate glass or the above bent glass, the first glass plate 11 and the second glass plate 12 may be glass plates having the same composition, or may be glass plates having different compositions.

In the case where the second glass plate 12 is not the above alkali borosilicate glass, a type of the glass plate is not particularly limited, and a known glass plate in the related art used for a vehicular window glass or the like may be used. Specific examples thereof include an alkali aluminosilicate glass, an alkali aluminoborosilicate glass, and a soda-lime glass. These glass plates may be colored to such an extent that the transparency thereof is not impaired, or may not be colored.

In the laminated glass according to the present embodiment, the second glass plate 12 may be an alkali aluminosilicate glass containing 1.0% or more of Al₂O₃, or may be an alkali aluminoborosilicate glass containing 1.0% or more of Al₂O₃ and 1.0% or more of B₂O₃. By using the above alkali aluminosilicate glass or alkali aluminoborosilicate glass as the second glass plate 12, chemical strengthening to be described later can be performed, and the strength can be improved.

In the above alkali aluminosilicate glass and alkali aluminoborosilicate glass, the content of Al₂O₃ is more preferably 5.0% or more, still more preferably 8.0% or more, and particularly preferably 10% or more, from the viewpoint of improving the weather resistance, the stain resistance, and chemical strengthening properties. In addition, the content of Al₂O₃ is preferably 18% or less, more preferably 15% or less, in order to reduce the glass viscosity and make it easier to produce.

In the above alkali aluminosilicate glass and alkali aluminoborosilicate glass, the content of R₂O is preferably 10% or more, more preferably 12% or more, and still more preferably 13% or more, from the viewpoint of chemical strengthening. In addition, the content of R₂O is preferably 22% or less, more preferably 20% or less, and still more preferably 18% or less, from the viewpoint of improving the stain resistance.

In the above alkali aluminoborosilicate glass, the content of B₂O₃ is preferably 2.0% or more, more preferably 3.0% or more, and still more preferably 4.0% or more, in order to improve the strength when the glass comes into contact with flying stones, vehicle keys, or the like. In addition, in the alkali aluminoborosilicate glass, the content of B₂O₃ is preferably 9.0% or less, more preferably 8.0% or less, and still more preferably 7.0% or less, from the viewpoint of improving the chemical durability and the weather resistance.

Specific examples of the above alkali aluminosilicate glass include a glass having the following composition. Each component is expressed in mol % in terms of oxides.
61%≤SiO₂≤77%
1.0%≤Al₂O₃≤20%
0.0%≤MgO≤15%
0.0%≤CaO≤10%
0.0%≤SrO≤10%
0.0%≤BaO≤1.0%
0.0%≤Li₂O≤15%
2.0%≤Na₂O≤15%
0.0%≤K₂O≤6.0%
0.0%≤ZrO₂≤4.0%
0.0%≤TiO₂≤1.0%
0.0%≤Y₂O₃≤2.0%
10%≤R₂O≤25%
0.0%≤RO≤20%
(R₂O represents the total content of Li₂O, Na₂O, and K₂O, and RO represents the total content of MgO, CaO, SrO, and BaO.)

Specific examples of the above alkali aluminoborosilicate glass include a glass having the following composition. Each component is expressed in mol % in terms of oxides.
61%≤SiO₂≤77%
1.0% ≤Al₂O₃≤20%
1.0%≤B₂O₃≤10%
0.0% ≤MgO≤15%
0.0%≤CaO≤10%
0.0%≤SrO≤1.0%
0.0%≤BaO≤1.0%
0.0%≤Li₂O≤15%
2.0%≤Na₂O≤15%
0.0%≤K₂O≤6.0%
0.0%≤ZrO₂≤4.0%
0.0%≤TiO₂≤1.0%
0.0%≤Y₂O₃≤2.0%
10%≤R₂O≤25%
0.0%≤RO≤20%
(R₂O represents the total content of Li₂O, Na₂O, and K₂O, and RO represents the total content of MgO, CaO, SrO, and BaO.)

In addition, in the laminated glass according to the present embodiment, the second glass plate 12 may be a soda-lime glass. The soda-lime glass may be a soda-lime glass containing less than 1.0% of Al₂O₃. Specific examples thereof include a glass having the following composition. Each component is expressed in mol % in terms of oxides.
60%≤SiO₂≤75%
0.0%≤Al₂O₃<1.0%
2.0%≤MgO≤11%
2.0%≤CaO≤10%
0.0%≤SrO≤3.0%
0.0% ≤BaO≤3.0%
10%≤Na₂O≤18%
0.0%≤K₂O≤8.0%
0.0%≤ZrO₂≤4.0%
0.0010%≤Fe₂O₃≤5.0%

In addition, in the laminated glass according to the present embodiment, the second glass plate 12 may be a soda-lime glass having the following composition. Each component is expressed in mol % in terms of oxides.
60%≤SiO₂≤75%
0.0%≤Al₂O₃≤3.5%
2.0%≤MgO≤11%
2.0%≤CaO≤10%
0.0%≤SrO≤3.0%
0.0%≤BaO≤3.0%
10%≤Na₂O≤18%
0.0%≤K₂O≤8.0%
0.0%≤ZrO₂≤4.0%
0.0010% ≤Fe₂O₃≤5.0%

The first glass plate 11 and the second glass plate 12 preferably have the same thickness. When the first glass plate 11 and the second glass plate 12 have the same thickness, the dimensional accuracy during the bending and forming is improved. In the present embodiment, it is more preferable that the thickness of the first glass plate 11 is larger than the thickness of the second glass plate 12. Note that, the thickness of the first glass plate 11 and the thickness of the second glass plate 12 may be different from each other.

The thickness of the first glass plate 11 is preferably 2.00 mm or more. When the thickness of the first glass plate 11 is 2.00 mm or more, the sound shielding property and the flying stone resistance are improved. The thickness of the first glass plate 11 is more preferably 2.25 mm or more, still more preferably 2.50 mm or more, particularly preferably 2.75 mm or more, and most preferably 3.00 mm or more. In addition, the thickness of the first glass plate 11 is preferably 5.00 mm or less. When the thickness of the first glass plate 11 is 5.00 mm or less, the weight of the laminated glass 10 is not too large, which is preferred from the viewpoint of reducing the power consumption and the fuel consumption in the case of being used for a vehicle. The thickness of the first glass plate 11 is more preferably 4.75 mm or less, still more preferably 4.50 mm or less, particularly preferably 4.25 mm or less, and most preferably 4.00 mm or less. That is, the thickness of the first glass plate 11 is preferably 2.00 mm or more and 5.00 mm or less.

The thickness of the second glass plate 12 is preferably less than 2.00 mm. When the thickness of the second glass plate 12 is less than 2.00 mm, even when the thickness of the first glass plate 11 is increased, the weight of the laminated glass 10 is not too large, which is preferred from the viewpoint of reducing the power consumption and the fuel consumption in the case of being used for a vehicle. The thickness of the second glass plate 12 is more preferably 1.80 mm or less, still more preferably 1.50 mm or less, particularly preferably 1.30 mm or less, and most preferably 1.10 mm or less. In addition, the thickness of the second glass plate 12 is preferably 0.500 mm or more. When the thickness of the second glass plate 12 is 0.500 mm or more, the strength is improved when vehicle keys or the like come into contact with the glass inside the vehicle. The thickness of the second glass plate 12 is more preferably 0.700 mm or more, still more preferably 0.800 mm or more, and particularly preferably 0.900 mm or more. That is, the thickness of the second glass plate 12 is preferably 0.500 mm or more and less than 2.00 mm.

In the laminated glass 10 according to the present embodiment, a total thickness of the first glass plate 11, the second glass plate 12, and the interlayer 13 is preferably 2.80 mm or more. When the total thickness is 2.80 mm or more, sufficient strength is obtained. The total thickness is more preferably 3.00 mm or more, still more preferably 3.50 mm or more, even more preferably 4.00 mm or more, particularly preferably 4.50 mm or more, and most preferably 4.70 mm or more. In addition, the total thickness may be 6.00 mm or less, and is preferably 5.80 mm or less, more preferably 5.60 mm or less, and still more preferably 5.40 mm or less, from the viewpoint of weight reduction. That is, the total thickness is preferably 2.80 mm or more and 6.00 mm or less.

Note that, in the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 gradually decreases.

One of the first glass plate 11 and the second glass plate 12 may be a chemically strengthened glass subjected to glass strengthening in order to improve the strength. The chemical strengthening treatment method is the same as that of the chemical strengthening treatment for the above alkali borosilicate glass. Examples of the chemically strengthened glass include the above alkali aluminosilicate glass and the above alkali aluminoborosilicate glass that have been subjected to a chemical strengthening treatment.

A shape of the first glass plate 11 and the second glass plate 12 may be a flat plate shape, or may be a curved shape having a curvature on the entire surface or a part thereof. In the case where the first glass plate 11 and the second glass plate 12 are curved, the first glass plate 11 and the second glass plate 12 may have a single bent shape that curves only in one direction of either the up-and-down direction or the right-and-left direction, or may have a multi-bent shape that curves both in the up-and-down direction and the right-and-left direction. In the case where the first glass plate 11 and the second glass plate 12 have a multi-bent shape, a radius of curvature thereof may be same or different in the up-and-down direction and the right-and-left direction. In the case where the first glass plate 11 and the second glass plate 12 are curved, the radius of curvature in the up-and-down direction and/or the right-and-left direction is preferably 1,000 mm or more. A shape of a main surface of the first glass plate 11 and the second glass plate 12 is a shape that fits a window opening of a vehicle on which the first glass plate 11 and the second glass plate 12 are to be mounted.

The interlayer 13 according to the present embodiment is sandwiched between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plate can be reduced.

As the interlayer 13, various organic resins generally used for a laminated glass used as a vehicular laminated glass in the related art may be used. As the organic resin, for example, a polyethylene (PE), an ethylene vinyl acetate copolymer (EVA), a polypropylene (PP), a polystyrene (PS), a methacrylic resin (PMA), polyvinyl chloride (PVC), polyethylene terephthalate (PET), polybutylene terephthalate (PBT), cellulose acetate (CA), a diallyl phthalate resin (DAP), a urea resin (UP), a melamine resin (MF), an unsaturated polyester (UP), polyvinyl butyral (PVB), polyvinyl formal (PVF), polyvinyl alcohol (PVAL), a vinyl acetate resin (PVAc), an ionomer (IO), polymethylpentene (TPX), vinylidene chloride (PVDC), polysulfone (PSF), polyvinylidene difluoride (PVDF), a methacrylate-styrene copolymer resin (MS), a polyarylate (PAR), polyarylsulfone (PASF), a polybutadiene (BR), polyethersulfone (PESF), or polyether ether ketone (PEEK) can be used. Among these, EVA and PVB are suitable from the viewpoint of transparency and adhesion, and particularly, PVB is more preferred because PVB can provide the sound shielding property.

A thickness of the interlayer 13 is preferably 0.300 mm or more, more preferably 0.500 mm or more, and still more preferably 0.700 mm or more, from the viewpoint of a reduction in impact force and the sound shielding property. In addition, the thickness of the interlayer 13 is preferably 1.00 mm or less, more preferably 0.900 mm or less, and still more preferably 0.800 mm or less, from the viewpoint of preventing a decrease in visible light transmittance. In addition, the thickness of the interlayer 13 is preferably in a range of 0.300 mm to 1.00 mm, and more preferably in a range of 0.700 mm to 0.800 mm.

The thickness of the interlayer 13 may be constant over the entire surface, or may be changed for each portion as necessary.

Note that, when a difference in linear expansion coefficient between the interlayer 13 and the first glass plate 11 or the second glass plate 12 is large, in the case where the laminated glass 10 is prepared through a heating step to be described later, the laminated glass 10 may be cracked or warped, resulting in a poor appearance. Therefore, the difference in linear expansion coefficient between the interlayer 13 and the first glass plate 11 or the second glass plate 12 is preferably as small as possible. The difference in linear expansion coefficient between the interlayer 13 and the first glass plate 11 or the second glass plate 12 may be represented by a difference between average linear expansion coefficients in a predetermined temperature range.

Particularly, a resin constituting the interlayer 13 has a low glass transition point, and thus a predetermined average linear expansion coefficient difference may be set in a temperature range equal to or lower than the glass transition point of the resin material. Note that, a difference in linear expansion coefficient between the resin material and the first glass plate 11 or the second glass plate 12 may be set at a predetermined temperature equal to or lower than the glass transition point of the resin material.

As the interlayer 13, an adhesive layer containing an adhesive may be used, and the adhesive is not particularly limited, and for example, an acrylic adhesive or a silicone adhesive can be used.

In the case where the interlayer 13 is an adhesive layer, it is not necessary to perform the heating step in the process of bonding the first glass plate 11 and the second glass plate 12, and thus the above cracks or warpage is less likely to occur.

### [Other Layers]

The laminated glass 10 according to the present embodiment may include layers other than the first glass plate 11, the second glass plate 12, and the interlayer 13 (hereinafter, also referred to as “other layers”) within a range that does not impair effects of the present invention. For example, a coating layer that provides a water repellent function, a hydrophilic function, an anti-fogging function, or the like, or an infrared reflection film may be provided.

Positions where the other layers are provided are not particularly limited, and the other layers may be provided on a surface of the laminated glass 10, or may be sandwiched between the first glass plate 11, the second glass plate 12, or the interlayer 13. In addition, the laminated glass 10 according to the present embodiment may include a black ceramic layer or the like which is disposed in a band shape on a part or all of a peripheral edge area for the purpose of hiding an attachment area to a frame body or the like, a wiring conductor, or the like.

A method for producing the laminated glass 10 according to the present embodiment may be the same as that for a known laminated glass in the related art. For example, through steps of laminating the first glass plate 11, the interlayer 13, and the second glass plate 12 in this order and performing heating and pressing, the laminated glass 10 having a configuration in which the first glass plate 11 and the second glass plate 12 are bonded via the interlayer 13 is obtained.

In the method for producing the laminated glass 10 according to the present embodiment, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having the configuration in which the first glass plate 11 and the second glass plate 12 are bonded via the interlayer 13 may be obtained.

In the laminated glass 10 according to the present embodiment, the visible light transmittance Tv defined in ISO-9050:2003 using a D65 light source is preferably 70% or more. The Tv is more preferably 71% or more, and still more preferably 72% or more. In addition, the Tv is, for example, 90% or less. That is, the Tv is, for example, 70% or more and 90% or less.

In the laminated glass 10 according to the present embodiment, a total solar transmittance Tts, as defined in ISO-13837:2008 convention A and measured at a wind speed of 4 m/s, is preferably 70% or less. When the total solar transmittance Tts of the laminated glass 10 according to the present embodiment is 70% or less, a sufficient heat shielding property is obtained. The Tts is more preferably 68% or less, and still more preferably 66% or less. In addition, the Tts is, for example, 55% or more. That is, the Tts is, for example, 55% or more and 70% or less.

In the laminated glass 10 according to the present embodiment, a chromaticity a* defined in JIS Z 8781-4:2013 using a D65 light source is preferably −5.0 or more, more preferably −4.0 or more, still more preferably −3.0 or more, and particularly preferably −2.0 or more. In addition, the a* is preferably 2.0 or less, more preferably 1.0 or less, and still more preferably 0 or less. That is, the a* is preferably −5.0 or more and 2.0 or less.

Further, in the laminated glass 10 according to the present embodiment, a chromaticity b* defined in JIS Z 8781-4:2013 using a D65 light source is preferably −5.0 or more, more preferably −3.0 or more, and still more preferably −1.0 or more. In addition, the b* is preferably 5.0 or less, more preferably 4.0 or less, still more preferably 3.0 or less, and particularly preferably 2.5 or less. That is, the b* is preferably −5.0 or more and 5.0 or less.

When the a* and the b* are within the above ranges, the glass plate according to the present embodiment has excellent designability and is suitable for use as an architectural window glass and a vehicular window glass.

Further, in the laminated glass 10 according to the present embodiment, c* determined by c*={(a*)²+(b*)²}^{1/2} is preferably 4.0 or less, more preferably 3.5 or less, still more preferably 3.0 or less, and particularly preferably 2.5 or less. In addition, the c* is not particularly limited in lower limit, and is generally 0.0 or more. That is, the c* is preferably 0.0 or more and 4.0 or less.

When the a*, the b*, and the c* are within the above ranges, the glass plate according to the present embodiment has excellent designability and is suitable for use as an architectural window glass and a vehicular window glass.

### [Architectural Window Glass and Vehicular Window Glass]

An architectural window glass and a vehicular window glass according to the present embodiment include the above alkali borosilicate glass. The architectural window glass and the vehicular window glass according to the present embodiment may be made of the above laminated glass.

Hereinafter, an example in which the laminated glass 10 according to the present embodiment is used as the vehicular window glass will be described with reference to the drawings.

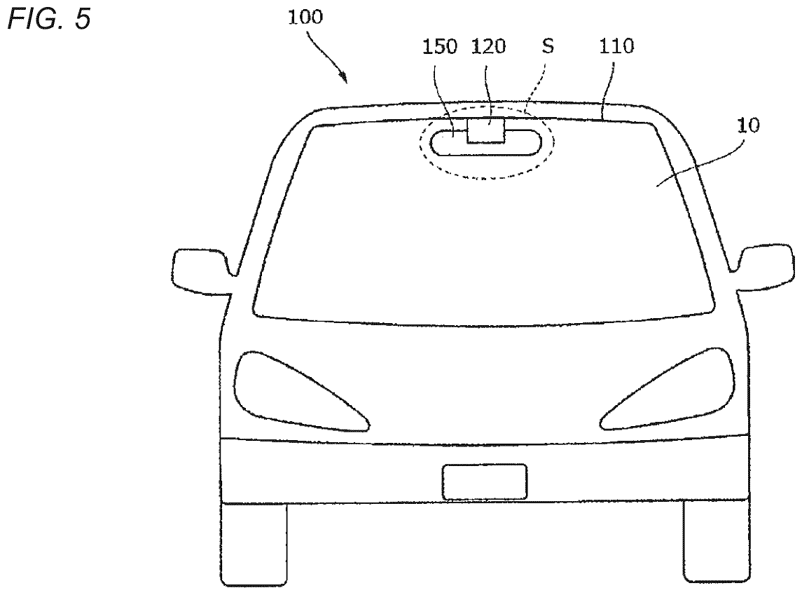

FIG. 5 is a conceptual view illustrating a state where the laminated glass 10 according to the present embodiment is mounted on an opening 110 formed at a front part of an automobile 100 to be used as an automobile window glass. In the laminated glass 10 used as the automobile window glass, a housing (case) 120 in which an information device or the like is housed for ensuring traveling safety of the vehicle may be attached to a surface on an inner side of the vehicle.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter wave radar, a stereo camera, an infrared laser, or the like, and transmits and receives a signal. The “signal” is an electromagnetic wave including a millimeter wave, visible light, or infrared light.

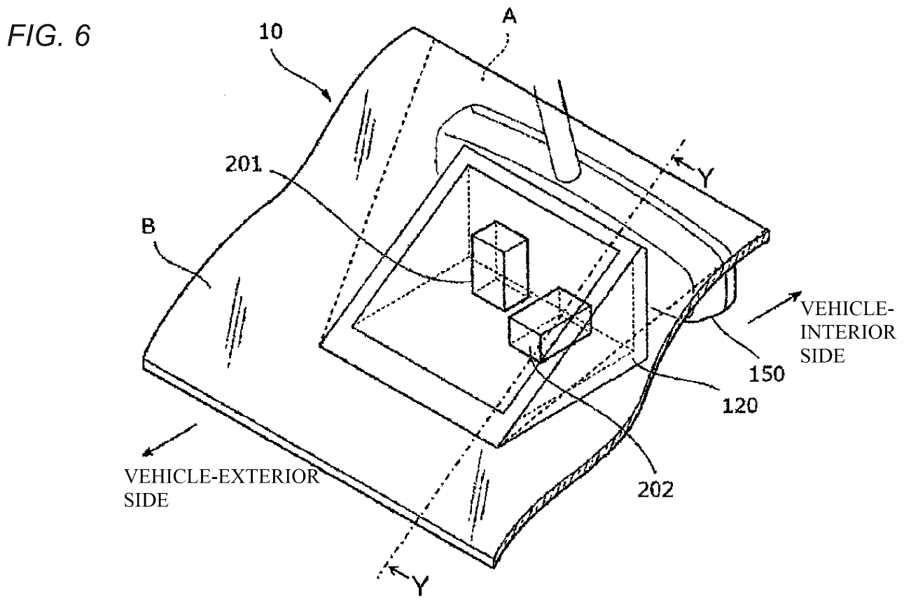

FIG. 6 is an enlarged view of a portion S in FIG. 5, and is a perspective view illustrating a portion where the housing 120 is attached to the laminated glass 10 according to the present embodiment. The housing 120 houses a millimeter wave radar 201 and a stereo camera 202 as the information device. The housing 120 in which the information device is housed is generally attached to a vehicle-exterior side with respect to a back mirror 150 and a vehicle-interior side with respect to the laminated glass 10, or may be attached to another portion.

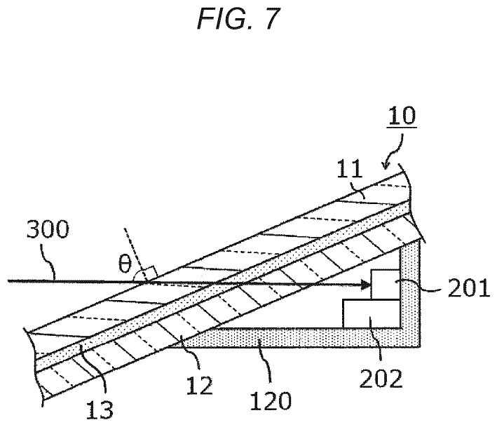

FIG. 7 is a cross-sectional view including a line Y-Y in FIG. 6 in a direction orthogonal to a horizontal line. The first glass plate 11 of the laminated glass 10 is preferably disposed on the vehicle-exterior side. With the above configuration, it is possible to provide a windshield that has high flying stone resistance and rigidity, is lightweight, and has high designability of a gray color.

### EXAMPLES

Hereinafter, the present invention will be specifically described with reference to Examples, but the present invention is not limited thereto.

### Preparation of Glass Plates in Example 1 to Example 35

Raw materials were charged into a platinum crucible so as to obtain each glass composition (unit: mol %) shown in Table 1 and Table 2, and melted at a temperature of 1,600° C. to 1,650° C. for 3 hours to obtain each molten glass. The molten glass was poured onto a carbon plate and slowly cooled. Both surfaces of the obtained plate-shaped glass were polished to obtain a glass plate having a thickness of 2.00 mm. Example 1 to Example 10 are Comparative Examples, and Example 11 to Example 35 are Inventive Examples.

In Table 1 and Table 2, in addition to the composition, the ratio of three-coordinated boron (B³ [%]), the ratio of four-coordinated boron (B⁴ [%]), the content of the three-coordinated boron in terms of B₂O₃ (B³ as B₂O₃ [mol %]), and the content of the four-coordinated boron in terms of B₂O₃ (B⁴ as B₂O₃ [mol %]), which were charged as raw materials, were measured, and the Fe-Redox, the visible light transmittance Tv, the solar transmittance Te, the ultraviolet transmittance Tuv, the chromaticity, the dominant wavelength Dw, the excitation purity Pe, the viscosity, the specific gravity, the Young's modulus, and the average linear expansion coefficient were measured.

Methods for determining numerical values shown in Table 1 and Table 2 are shown below.

### (1) Coordination Number of Boron:

The ratio of the coordination number of boron atoms in the glass was analyzed by NMR. The NMR measurement conditions are as follows. Measurement device: nuclear magnetic resonance device ECZ700 manufactured by JEOL Ltd., resonance frequency: 156.38MHz, rotation number: 15 kHz, probe: 3.2 mm for solid, flip angle: 90°, pulse repetition waiting time: 16 sec

Measurement was performed using a single pulse method, with adamantane used as an external standard (28.46 ppm and 37.85 ppm of 13C). The measurement results were subjected to phase correction and baseline correction using NMR software Delta manufactured by JEOL Ltd., then fitting was performed using a Gaussian function to calculate the ratios of three coordination and four coordination, and an average coordination number was determined.

The phase correction and the baseline correction were appropriately performed by subtracting the spectrum of an empty cell containing no sample. For peak fitting, the peak top was set at 20 ppm to 8 ppm for three coordination and 5 ppm to −5 ppm for four coordination, and good fitting was obtained by setting the peak width appropriately (such that the ratio between the coordination numbers was at most 1.5 times or less).

### (2) Fe-Redox:

The Fe-Redox was determined by the following method.

A crushed glass was decomposed with a mixed acid of hydrofluoric acid and hydrochloric acid at room temperature, then a certain amount of the decomposition solution was dispensed into a plastic container, and a hydroxylammonium chloride solution was added to reduce Fe³⁺ in the sample solution to Fe²⁺. Thereafter, a 2,2′-dipyridyl solution and an ammonium acetate buffer solution were added to develop the color of Fe²⁺. A color development solution was adjusted to a certain volume with ion exchanged water, and an absorbance at a wavelength of 522 nm was measured with an absorption spectrophotometer. Then, a concentration was calculated based on a calibration curve prepared by using the standard solution to determine the amount of Fe²⁺. Since Fe³⁺ in the sample solution is reduced to Fe²⁺, the amount of Fe²⁺ means “[Fe²⁺]+[Fe³⁺]” in the sample.

Next, a crushed glass was decomposed with a mixed acid of hydrofluoric acid and hydrochloric acid at room temperature, then a certain amount of the decomposition solution was dispensed into a plastic container, and a 2,2′-dipyridyl solution and an ammonium acetate buffer solution were quickly added to develop the color of Fe²⁺ only. A color development solution was adjusted to a certain volume with ion exchanged water, and an absorbance at a wavelength of 522 nm was measured with a spectrophotometer (U-4100 manufactured by Hitachi, Ltd.). Then, a concentration was calculated based on a calibration curve prepared by using the standard solution to obtain the amount of Fe²⁺. The amount of Fe²⁺ means [Fe²⁺] in the sample.

Then, the Fe-Redox: [Fe²⁺]/([Fe²⁺]+[Fe³⁺]) was determined based on the obtained [Fe²⁺] and [Fe²⁺]+[Fe³⁺].

### (3) Visible Light Transmittance (Tv):

The Tv, when the thickness of the glass plate was converted into 2.0 mm, was measured with a method defined in ISO-9050:2003 using a D65 light source. Note that, the Tv was measured using a spectrophotometer LAMBDA 950 manufactured by Perkinelmer.

### (4) Solar Transmittance (Te):

The solar transmittance Te is a solar transmittance calculated by measuring the transmittance using a spectrophotometer, i.e., a spectrophotometer LAMBDA 950manufactured by Perkinelmer according to the provisions in ISO-9050:2003.

### (5) Ultraviolet Transmittance (Tuv):

The Tuv, when the thickness of the glass plate was converted into 2.0 mm, was measured with a method defined in ISO-9050:2003. Note that, the Tuv was measured using a spectrophotometer LAMBDA 950 manufactured by Perkinelmer.

### (6) Chromaticity (L*, a*, b*, and c*):

The chromaticities L*, a*, and b* defined in JIS Z 8781-4:2013 were measured using a D65 light source. The obtained values of a* and b* were substituted into the following equation to determine c*.

$${c}^{*} = {\{ {( {a}^{*} )}^{2} + {( {b}^{*} )}^{2} \}}^{1 / 2}$$

(7) Dominant Wavelength (Dw): The dominant wavelength Dw of the transmitted light is a dominant wavelength of the transmitted light calculated according to JIS Z 8701:1999.

### (8) Excitation Purity (Pe):

The excitation purity Pe is an excitation purity calculated according to JIS Z 8701:1999.

### (9) Viscosity:

The temperature T₁₁ at which the viscosity η was 10¹¹ dPa·s and the temperature T₁₂ at which the viscosity η was 10¹² dPa·s were measured with a beam bending method, the temperature T₁₁ and the temperature T₁₂ being criterion for bending workability.

### (10) Specific Gravity:

The specific gravity of about 20 g of a glass mass containing no bubble and cut out from the glass plate was measured with Archimedes method.

### (11) Young's Modulus:

The Young's modulus was measured at 25° C. using an ultrasonic pulse method (Olympus, DL35) based on JIS R1602:1995 “Testing methods for elastic modulus of fine ceramics”.

### (12) Average Linear Expansion Coefficient at 50° C. to 350° C. (CTE₅₀₋₃₅₀):

The average linear expansion coefficient was measured using a differential thermal dilatometer (TMA) and was determined based on the provisions in JIS R3102:1995.

The measurement results are shown in Table 1 and Table 2. Note that, in Table 1 and Table 2, “−” indicates that calculation is not possible because B₂O₃ is not contained, and a blank indicates that no measurement is made.

TABLE 1

| mol % | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| SiO₂ | 69.5 | 83.4 | 83.3 | 71.9 | 71.9 | 75.8 | 71.9 | 71.9 | 75.0 |
| Al₂O₃ | 0.9 | 1.2 | 1.2 | 8.0 | 6.0 | 6.0 | 10.0 | 2.0 | 4.0 |
| B₂O₃ | 0.0 | 11.6 | 11.5 | 12.0 | 16.0 | 12.0 | 8.0 | 18.0 | 13.0 |
| MgO | 7.1 | 0.0 | 0.0 | 0.0 | 0.0 | 0.0 | 0.0 | 0.0 | 0.0 |
| CaO | 9.1 | 0.0 | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 | 0.0 | 3.5 |
| Na₂O | 12.6 | 3.3 | 3.3 | 8.0 | 6.0 | 6.0 | 10.0 | 8.0 | 4.2 |
| K₂O | 0.6 | 0.5 | 0.5 | 0.0 | 0.0 | 0.0 | 0.0 | 0.0 | 0.0 |
| Fe₂O₃ | 0.18 | 0.02 | 0.19 | 0.20 | 0.20 | 0.20 | 0.20 | 0.20 | 0.19 |
| SiO₂ + Al₂O₃ + B₂O₃ | 70 | 96 | 96 | 92 | 94 | 94 | 90 | 92 | 92 |
| [mol %] | | | | | | | | | |
| R₂O [mol %] | 13.2 | 3.8 | 3.7 | 8.0 | 6.0 | 6.0 | 10.0 | 8.0 | 7.8 |
| B³ [%] | — | 72 | 72 | 97 | 100 | 97 | 100 | 62 | 68 |
| B⁴ [%] | — | 28 | 28 | 3 | 0 | 3 | 0 | 38 | 32 |
| B³ as B₂O₃ [mol %] | — | 8.4 | 8.4 | 11.6 | 16.0 | 11.6 | 8.0 | 11.2 | 8.8 |
| B⁴ as B₂O₃ [mol %] | — | 3.2 | 3.2 | 0.4 | 0.0 | 0.4 | 0.0 | 6.8 | 4.2 |
| Fe-Redox [%] | | 10 or | 10 or | 10 or | 10 or | 10 or | 10 or | 10 or | 10 or |
| | | more | more | more | more | more | more | more | more |
| Tv_D65 (ISO- | 86 | 94 | 75 | 72 | 68 | 66 | 73 | 83 | 77 |
| 9050:2003) [%] | | | | | | | | | |
| Te (ISO-9050:2003) | 73 | 93 | 77 | 73 | 71 | 68 | 73 | 81 | 74 |
| Tuv (ISO-9050:2003) | 47 | 85 | 36 | 10 | 5 | 7 | 18 | 45 | 37 |
| [%] | | | | | | | | | |
| L* (D65) | 91.4 | 95.1 | 87.1 | 85.6 | 83.7 | 82.6 | 86.3 | 90.7 | 87.9 |
| a* (D65) | −2.6 | −0.1 | 0.3 | 0.3 | 0.0 | 0.4 | 0.4 | −0.4 | 0.0 |
| b* (D65) | 0.3 | 0.2 | 2.0 | 3.8 | 4.7 | 4.1 | 3.0 | 1.8 | 1.6 |
| c* (D65) | 2.6 | 0.2 | 2.1 | 3.8 | 4.7 | 4.1 | 3.0 | 1.9 | 1.6 |
| Dw [nm] | 500 | 571 | 580 | 579 | 578 | 579 | 580 | 575 | 577 |
| Pe [%] | 1.1 | 0.3 | 2.4 | 4.3 | 5.4 | 4.9 | 3.5 | 1.9 | 1.9 |
| Tv/Te [—] | 1.17 | 1.01 | 0.97 | 0.98 | 0.96 | 0.96 | 1.01 | 1.03 | 1.04 |
| T₁₁ [° C.] | 613 | 650 | 650 | | | | | | |
| T₁₂ [° C.] | 590 | 609 | 609 | | | | | | |
| Specific gravity | 2.51 | 2.23 | 2.23 | 2.27 | 2.22 | 2.23 | 2.31 | 2.28 | 2.27 |
| Young's modulus | 74 | 64 | 64 | 59 | 55 | 58 | 63 | 65 | 69 |
| [GPa] | | | | | | | | | |
| CTE₅₀₋₃₅₀ [×10-7/° C.] | 91 | 33 | 33 | 52 | 46 | | | | |

| mol % | Ex. 10 | Ex. 11 | Ex. 12 | Ex. 13 | Ex. 14 | Ex. 15 | Ex. 16 | Ex. 17 |
|---|---|---|---|---|---|---|---|---|
| SiO₂ | 75.3 | 77.8 | 76.6 | 73.7 | 72.7 | 71.7 | 79.3 | 79.1 |
| Al₂O₃ | 2.9 | 2.0 | 2.8 | 2.8 | 3.9 | 4.9 | 2.0 | 3.2 |
| B₂O₃ | 12.3 | 12.0 | 11.3 | 13.2 | 13.2 | 13.2 | 11.5 | 10.0 |
| MgO | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 |
| Li₂O | 2.5 | 0.0 | 2.5 | 2.5 | 3.5 | 4.5 | 1.7 | 2.4 |
| Na₂O | 6.8 | 8.0 | 6.3 | 7.3 | 6.3 | 5.3 | 5.1 | 4.5 |
| K₂O | 0.2 | 0.0 | 0.2 | 0.2 | 0.2 | 0.2 | 0.2 | 0.5 |
| Fe₂O₃ | 0.02 | 0.19 | 0.19 | 0.19 | 0.19 | 0.19 | 0.19 | 0.19 |
| SiO₂ + Al₂O₃ + B₂O₃ | 90 | 92 | 91 | 90 | 90 | 90 | 93 | 92 |
| [mol %] | | | | | | | | |
| R₂O [mol %] | 9.5 | 8.0 | 9.0 | 10.0 | 10.0 | 10.0 | 7.0 | 7.5 |
| B³ [%] | 47 | 46 | 47 | 47 | 54 | 61 | 58 | 54 |
| B⁴ [%] | 53 | 54 | 53 | 53 | 46 | 39 | 42 | 46 |
| B³ as B₂O₃ [mol %] | 5.8 | 5.5 | 5.3 | 6.2 | 7.2 | 8.1 | 6.7 | 5.4 |
| B⁴ as B₂O₃ [mol %] | 6.5 | 6.5 | 6.0 | 7.0 | 6.1 | 5.2 | 4.8 | 4.6 |
| Fe-Redox [%] | 24 | 10 or more | 10 or more | 10 or more | 10 or more | 10 or more | 10 or more | 10 or more |
| | 92 | 85 | 82 | 83 | 82 | 80 | 81 | 81 |
| Tv_D65 (ISO- | | | | | | | | |
| 9050:2003) [%] | 91 | 78 | 74 | 74 | 75 | 74 | 76 | 74 |
| Te (ISO-9050:2003) | | | | | | | | |
| Tuv (ISO-9050:2003) | 80 | 52 | 48 | 48 | 44 | 40 | 45 | 46 |
| [%] | | | | | | | | |
| L* (D65) | 94.3 | 91.3 | 90.1 | 90.4 | 90.0 | 89.1 | 89.5 | 89.5 |
| a* (D65) | 0.2 | −0.8 | −1.0 | −1.0 | −0.7 | −0.4 | −0.4 | −0.6 |
| b* (D65) | 0.2 | 1.0 | 0.8 | 0.7 | 1.0 | 1.3 | 1.3 | 1.1 |
| c* (D65) | 0.3 | 1.3 | 1.3 | 1.3 | 1.3 | 1.3 | 1.4 | 1.2 |
| Dw [nm] | 564 | 564 | 555 | 550 | 567 | 573 | 572 | 568 |
| Pe [%] | 0.3 | 1.0 | 0.6 | 0.4 | 1.0 | 1.3 | 1.4 | 1.1 |
| Tv/Te [—] | 1.01 | 1.10 | 1.12 | 1.12 | 1.09 | 1.07 | 1.07 | 1.08 |
| T₁₁ [° C.] | 595 | 640 or less | 599 | 589 | 581 | 640 or less | 620 | 609 |
| T₁₂ [° C.] | 565 | | 570 | 561 | 555 | | 592 | 578 |
| Specific gravity | 2.33 | 2.32 | 2.32 | 2.33 | 2.32 | 2.30 | 2.28 | 2.29 |
| Young's modulus | 74 | 71 | 74 | 74 | 73 | 72 | 70 | 72 |
| [GPa] | | | | | | | | |
| CTE₅₀₋₃₅₀ [×10-7/° C.] | 54 | 49 | 40 or more | 40 or more | 40 or more | 40 or more | 40 or more | 40 or more |

TABLE 2

| mol % | Ex. 18 | Ex. 19 | Ex. 20 | Ex. 21 | Ex. 22 | Ex. 23 | Ex. 24 | Ex. 25 | Ex. 26 |
|---|---|---|---|---|---|---|---|---|---|
| SiO₂ | 75.2 | 75.3 | 75.1 | 75.0 | 75.2 | 78.1 | 75.2 | 77.6 | 75.9 |
| Al₂O₃ | 2.8 | 2.9 | 2.8 | 2.8 | 2.8 | 1.7 | 1.8 | 2.0 | 2.0 |
| B₂O₃ | 12.3 | 12.3 | 12.3 | 12.3 | 12.3 | 13.0 | 13.7 | 12.2 | 12.0 |
| MgO | 0.0 | 0.0 | 0.0 | 0.0 | 0.0 | 0.0 | 0.0 | 0.0 | 0.0 |
| CaO | 0.0 | 0.0 | 0.0 | 0.0 | 0.0 | 0.0 | 0.0 | 0.0 | 2.0 |
| Li₂O | 2.5 | 2.5 | 2.5 | 2.5 | 2.5 | 0.8 | 0.0 | 0.0 | 0.0 |
| Na₂O | 6.8 | 6.8 | 6.8 | 6.8 | 6.8 | 5.5 | 7.8 | 6.5 | 8.0 |
| K₂O | 0.2 | 0.2 | 0.2 | 0.2 | 0.2 | 0.7 | 1.4 | 1.5 | 0.0 |
| Fe₂O₃ | 0.19 | 0.10 | 0.29 | 0.39 | 0.15 | 0.19 | 0.20 | 0.20 | 0.19 |
| SiO₂ + Al₂O₃ + B₂O₃ | 90 | 90 | 90 | 90 | 90 | 93 | 91 | 92 | 90 |
| [mol %] | | | | | | | | | |
| R₂O [mol %] | 9.5 | 9.5 | 9.5 | 9.5 | 9.5 | 7.0 | 9.2 | 8.0 | 8.0 |
| B³ [%] | 47 | 47 | 47 | 47 | 47 | 55 | 41 | 50 | 43 |
| B⁴ [%] | 53 | 53 | 53 | 53 | 53 | 45 | 59 | 50 | 57 |
| B³ as B₂O₃ | 5.8 | 5.8 | 5.8 | 5.8 | 5.8 | 7.1 | 5.6 | 6.1 | 5.2 |
| [mol %] | | | | | | | | | |
| B⁴ as B₂O₃ | 6.5 | 6.5 | 6.5 | 6.5 | 6.5 | 5.9 | 8.1 | 6.1 | 6.8 |
| [mol %] | | | | | | | | | |
| Fe-Redox [%] | 21 | 20 | 20 | 19 | 32 | 10 or | 10 or | 10 or | 10 or |
| | | | | | | more | more | more | more |
| Tv_D65 (ISO- | 85 | 90 | 78 | 69 | 86 | 84 | 85 | 85 | 86 |
| 9050:2003) [%] | | | | | | | | | |
| Te (ISO- | 78 | 86 | 72 | 64 | 78 | 78 | 77 | 77 | 77 |
| 9050:2003) [%] | | | | | | | | | |
| Tuv (ISO- | 46 | 62 | 33 | 22 | 54 | 50 | 53 | 54 | 43 |
| 9050:2003) [%] | | | | | | | | | |
| L* (D65) | 91.2 | 93.4 | 88.3 | 84.1 | 91.6 | 91.0 | 91.5 | 91.2 | 91.8 |
| a* (D65) | −0.9 | −0.5 | −1.0 | −1.0 | −0.9 | −0.6 | −1.0 | −0.8 | −1.2 |
| b* (D65) | 1.2 | 0.6 | 2.1 | 3.1 | 0.6 | 1.2 | 1.0 | 1.1 | 0.9 |
| c* (D65) | 1.5 | 0.8 | 2.3 | 3.2 | 1.1 | 1.4 | 1.4 | 1.3 | 1.5 |
| Dw [nm] | 565 | 562 | 570 | 573 | 550 | 569 | 560 | 565 | 553 |
| Pe [%] | 1.1 | 0.6 | 2.1 | 3.3 | 0.2 | 1.2 | 0.8 | 1.0 | 0.7 |
| Tv/Te [—] | 1.08 | 1.05 | 1.09 | 1.08 | 1.10 | 1.08 | 1.11 | 1.10 | 1.12 |
| T₁₁ [° C.] | 595 | 595 | 595 | 595 | 595 | 640 or | 640 or | 640 or | 640 or |
| | | | | | | less | less | less | less |
| T₁₂ [° C.] | 565 | 565 | 565 | 565 | 565 | | | | |
| Specific gravity | 2.33 | 2.33 | 2.33 | 2.33 | 2.33 | 2.30 | 2.34 | 2.32 | 2.35 |
| Young's modulus | 74 | 74 | 74 | 74 | 74 | 71 | 73 | 71 | 74 |
| [GPa] | | | | | | | | | |
| CTE₅₀₋₃₅₀ | 54 | 54 | 54 | 54 | 54 | 40 or | 40 or | 40 or | 40 or |
| [×10-7/° C.] | | | | | | more | more | more | more |
| mol % | Ex. 27 | Ex. 28 | Ex. 29 | Ex. 30 | Ex. 31 | Ex. 32 | Ex. 33 | Ex. 34 | Ex. 35 |
| SiO₂ | 75.9 | 75.9 | 70.0 | 70.0 | 75.2 | 75.2 | 75.2 | 77.8 | 75.2 |
| Al₂O₃ | 2.0 | 2.0 | 1.9 | 1.9 | 2.8 | 2.8 | 1.5 | 2.6 | 1.5 |
| B₂O₃ | 12.0 | 12.0 | 18.0 | 18.0 | 12.3 | 12.3 | 12.3 | 10.9 | 12.3 |
| MgO | 1.0 | 0.0 | 0.0 | 2.0 | 0.0 | 0.0 | 0.0 | 0.0 | 0.0 |
| CaO | 1.0 | 4.0 | 2.0 | 0.0 | 0.0 | 0.0 | 0.0 | 0.0 | 0.0 |
| Li₂O | 0.0 | 0.0 | 0.0 | 0.0 | 2.5 | 2.5 | 3.4 | 0.0 | 0.0 |
| Na₂O | 8.0 | 6.0 | 8.0 | 8.0 | 6.8 | 6.8 | 7.2 | 6.5 | 9.5 |
| K₂O | 0.0 | 0.0 | 0.0 | 0.0 | 0.2 | 0.2 | 0.3 | 2.0 | 1.3 |
| Fe₂O₃ | 0.19 | 0.19 | 0.20 | 0.19 | 0.19 | 0.19 | 0.19 | 0.19 | 0.19 |
| SiO₂ + Al₂O₃ + B₂O₃ | 90 | 90 | 90 | 90 | 90 | 90 | 89 | 91 | 89 |
| [mol %] | | | | | | | | | |
| R₂O [mol %] | 8.0 | 6.0 | 8.0 | 8.0 | 9.5 | 9.5 | 10.8 | 8.5 | 10.8 |
| B³ [%] | 47 | 49 | 56 | 59 | 47 | 47 | 23 | 51 | 24 |
| B⁴ [%] | 53 | 51 | 44 | 41 | 53 | 53 | 77 | 49 | 76 |
| B³ as B₂O₃ | 5.6 | 5.9 | 10.1 | 10.6 | 5.8 | 5.8 | 2.8 | 5.6 | 2.9 |
| [mol %] | | | | | | | | | |
| B⁴ as B₂O₃ | 6.4 | 6.1 | 7.9 | 7.4 | 6.5 | 6.5 | 9.5 | 5.3 | 9.1 |
| [mol %] | | | | | | | | | |
| Fe-Redox [%] | 10 or | 10 or | 10 or | 10 or | 11 | 17 | 10 or | 10 or | 10 or |
| | more | more | more | more | | | more | more | more |
| Tv_D65 (ISO- | 87 | 85 | 85 | 85 | 88 | 86 | 86 | 83 | 86 |
| 9050:2003) [%] | | | | | | | | | |
| Te (ISO- | 78 | 78 | 80 | 80 | 84 | 81 | 77 | 74 | 75 |
| 9050:2003) [%] | | | | | | | | | |
| Tuv (ISO- | 46 | 30 | 34 | 35 | 44 | 44 | 44 | 55 | 50 |
| 9050:2003) [%] | | | | | | | | | |
| L* (D65) | 91.9 | 91.4 | 91.3 | 91.3 | 92.4 | 91.8 | 91.7 | 90.6 | 91.8 |
| a* (D65) | −1.1 | −1.2 | −0.8 | −0.7 | −0.8 | −0.7 | −1.4 | −1.0 | −1.6 |
| b* (D65) | 1.1 | 1.5 | 1.6 | 1.8 | 1.7 | 1.2 | 0.8 | 0.8 | 0.6 |
| c* (D65) | 1.6 | 1.9 | 1.8 | 1.9 | 1.9 | 1.8 | 1.6 | 1.3 | 1.7 |
| Dw [nm] | 560 | 565 | 571 | 571 | 570 | 571 | 544 | 553 | 522 |
| Pe [%] | 0.9 | 1.4 | 1.6 | 1.8 | 1.7 | 1.8 | 0.6 | 0.8 | 0.4 |
| Tv/Te [—] | 1.10 | 1.10 | 1.07 | 1.06 | 1.05 | 1.07 | 1.12 | 1.13 | 1.15 |
| T₁₁ [° C.] | 640 or | 640 or | 640 or | 640 or | 595 | 595 | | | |
| | less | less | less | less | | | | | |
| T₁₂ [° C.] | | | | | 565 | 565 | | | |
| Specific gravity | 2.33 | 2.33 | 2.32 | 2.29 | 2.33 | 2.33 | 2.36 | 2.33 | 2.40 |
| Young's modulus | 72 | 73 | 70 | 66 | 74 | 74 | 79 | 71 | 78 |
| [GPa] | | | | | | | | | |
| CTE₅₀₋₃₅₀ | 40 or | 40 or | 40 or | 40 or | 54 | 54 | 58 | 56 | 64 |
| [×10-7/° C.] | more | more | more | more | | | | | |

The glasses in Example 11 to Example 35 which are Inventive Examples have a solar transmittance Te of 90% or less, a dominant wavelength Dw of 520 nm or more and 574 nm or less, and an excitation purity Pe of 4.0% or less, have an excellent heat shielding property, and exhibit designability.

On the other hand, the glass in Example 1 which is Comparative Example is free of B₂O₃, and thus has a dominant wavelength Dw of 500 nm, showing designability inferior to that in Inventive Examples.

In addition, the glass in Example 2 which is Comparative Example has a content of Fe₂O₃ of less than 0.03% and a ratio of three-coordinated boron of more than 61%, and thus has a solar transmittance Te of 93%, showing a heat shielding property inferior to that in Inventive Examples.

In addition, Example 3 and Example 7-9 which are Comparative Examples have a ratio of three-coordinated boron of more than 61%, and thus have a dominant wavelength Dw of more than 574 nm, showing designability inferior to that in Inventive Examples.

In addition, Example 4 to Example 6 which are Comparative Examples have a ratio of three-coordinated boron of more than 61%, and thus have dominant wavelength Dw of more than 574 nm and an excitation purity Pe of more than 4.0%, showing designability inferior to that in Inventive Examples.

In addition, the glass in Example 10 as Comparative Example has a content of Fe₂O₃ of less than 0.03%, and thus has a solar transmittance Te of 91%, showing a heat shielding property inferior to that in Inventive Examples.

Although the present invention has been described in detail with reference to specific embodiments, it is apparent to those skilled in the art that various changes and modifications can be made without departing from the spirit and scope of the present invention. The present application is based on a Japanese Patent Application (Japanese Patent Application No. 2022-099058) filed on Jun. 20, 2022, the content of which is incorporated herein by reference.

### REFERENCE SIGNS LIST

10 laminated glass
11 first glass plate
12 second glass plate
13 interlayer
100 automobile
110 opening
120 housing
150 back mirror
201 millimeter wave radar
202 stereo camera
300 radio wave

1. An alkali borosilicate glass, wherein the alkali borosilicate glass has a content of total iron of 0.03% or more in terms of Fe₂O₃ in mol % in terms of oxides and a ratio of three-coordinated boron to a total amount of the three-coordinated boron and four-coordinated boron of 61% or less, and is substantially free of Se and CoO, and when a thickness of the alkali borosilicate glass is converted into 2.0 mm, a solar transmittance Te specified in ISO-9050:2003 is 90% or less, a dominant wavelength Dw measured using a standard C light source specified in JIS Z 8701:1999 is 520 nm or more and 574 nm or less, and an excitation purity Pe measured using the standard C light source specified in JIS Z 8701:1999 is 4.0% or less.

2. The alkali borosilicate glass according to claim 1, wherein the alkali borosilicate glass has a ratio Tv/Te of 1.05 or more when the thickness of the alkali borosilicate glass is converted into 2.0 mm, where Tv is a visible light transmittance defined in ISO-9050:2003 using a D65 light source and Te is the solar transmittance defined in ISO-9050:2003.

3. The alkali borosilicate glass according to claim 1, wherein the alkali borosilicate glass has a visible light transmittance Tv of 75% or more when the thickness of the alkali borosilicate glass is converted into 2.0 mm where the visible light transmittance Tv is defined in ISO-9050:2003 using a D65 light source.

4. The alkali borosilicate glass according to claim 1, wherein the alkali borosilicate glass has a visible light transmittance Tv of less than 75% when the thickness of the alkali borosilicate glass is converted into 2.0 mm where the visible light transmittance Tv is defined in ISO-9050:2003 using a D65 light source.

5. The alkali borosilicate glass according to claim 1, wherein the content of the total iron in terms of Fe₂O₃ is 0.040% or more and 0.60% or less in mol % in terms of oxides.

6. The alkali borosilicate glass according to claim 1, wherein the alkali borosilicate glass has a Young's modulus of 65 GPa or more.

7. The alkali borosilicate glass according to claim 1, wherein a temperature T₁₁ at which a glass viscosity is 10¹¹ dPa·s is 640° C. or lower.

8. The alkali borosilicate glass according to claim 1, wherein the alkali borosilicate glass has a composition comprising, in mol % in terms of oxides, 70%≤SiO₂≤80%, 8.0% ≤B₂O₃≤20%, 1.0%≤Al₂O₃≤5.0%, 0.0%≤Li₂O≤5.0%, 2.0% ≤Na₂O≤10%, 0.0%≤K₂O≤5.0%, 0.0%≤MgO≤5.0%, 0.0%≤CaO≤5.0%, 0.0%≤SrO≤5.0%, 0.0%≤BaO≤5.0%, 89%≤SiO₂+B₂O₃+Al₂O₃, and 5.0%≤Li₂O+Na₂O+K₂O.

9. The alkali borosilicate glass according to claim 8, wherein the content of the total iron in terms of Fe₂O₃ is 0.040% or more and 0.60% or less in mol % in terms of oxides, and a mass ratio of divalent iron in terms of Fe₂O₃ in the total iron in terms of Fe₂O₃ is 10% or more.

10. The alkali borosilicate glass according to claim 8, wherein the composition of the alkali borosilicate glass includes Li₂O.

11. A bent glass, comprising:
the alkali borosilicate glass of claim 1.

12. A laminated glass, comprising:
a first glass plate;
a second glass plate; and
an interlayer sandwiched between the first glass plate and the second glass plate,
wherein the first glass plate is the alkali borosilicate glass of claim 1.

13. The laminated glass according to claim 12, wherein the second glass plate is the alkali borosilicate glass of claim 1.

14. The laminated glass according to claim 12, wherein the second glass plate is an alkali aluminosilicate glass having a composition comprising 1.0% or more of Al₂O₃ in mol % in terms of oxides.

15. The laminated glass according to claim 12, wherein the second glass plate is an alkali aluminoborosilicate glass having a composition comprising 1.0% or more of Al₂O₃ and 1.0% or more of B₂O₃ in mol % in terms of oxides.

16. The laminated glass according to claim 12, wherein the second glass plate is a chemically strengthened glass.

17. The laminated glass according to claim 12, wherein the second glass plate is a soda-lime glass.

18. A vehicular window glass, comprising:
the alkali borosilicate glass of claim 1.

19. A vehicular window glass, comprising:
the laminated glass of claim 12.

20. An architectural window glass, comprising:
the alkali borosilicate glass of claim 1.
